(19) United States
(12) Patent Application Publication
(10) Pub. No.: US 2025/0130352 A1
(43) Pub. Date: Apr. 24, 2025

(54) COATED MICROSTRUCTURED FILMS, METHODS OF MAKING SAME, AND METHODS OF MAKING LIGHT CONTROL FILMS

(71) Applicant: 3M INNOVATIVE PROPERTIES COMPANY, St. Paul, MN (US)

(72) Inventors: Daniel J. Schmidt, Woodbury, MN (US); Morgan A. Priolo, Georgetown, TX (US); Caleb T. Nelson, Mckinney, TX (US); Kevin W. Gotrik, Hudson, WI (US)

(21) Appl. No.: 18/681,559

(22) PCT Filed: Aug. 15, 2022
(86) PCT No.: PCT/IB2022/057630

§ 371 Date: Feb. 6, 2024

Related U.S. Application Data
(60) Provisional application No. 63/248,085, filed on Sep. 24, 2021.

(51) Int. Cl. G02B 5/00; G02B 1/04

(52) U.S. Cl. CPC G02B 5/003; G02B 1/04; G02B 2207/123

(57) ABSTRACT

The present disclosure provides a coated microstructured film (100a-c). The coated film includes microstructures (110) extending across a first surface of the microstructured film (100a-e) and a coating (130) on a first portion of at least some of the microstructures (110). The coating (130) includes one or more polyelectrolytes and has an average thickness T. A second portion of the coated microstructures either lacks the coating or has the coating with an average thickness of no more than 50% of T. The coating (130) is essentially free of any light absorptive material. A method of making the coated microstructured film (100a-c) is also provided. The method includes obtaining a microstructured film (100a), applying a coating (130) containing one or more polyelectrolytes to at least some of the microstructures (110), and removing at least some of the coating (130) from a second portion of the coated microstructures. Additionally, the present disclosure provides a method of making a light control film (110d. 100e). The method includes the above method as well as either infusing a light absorptive material into the coating of the coated microstructured film (100b-d) or applying a layer of a pigment on the coating. Such a light control film exhibits a transmission of visible light of 75% or greater at a viewing angle of 0 degrees.

### BACKGROUND

Various microstructured films are known, having engineered microstructured shapes. Further developments in films/articles having microstructured surfaces would be desirable.

### SUMMARY

In a first aspect, a coated microstructured film is provided. The coated microstructured film comprises a) a plurality of microstructures extending across a first surface of the microstructured film; and b) a coating disposed on a first portion of at least some of the microstructures. The coating comprises one or more polyelectrolytes and has an average thickness T. A second portion of the coated microstructures either lacks the coating or comprises the coating disposed thereon having an average thickness of no more than 50% of T. The coating is essentially free of any light absorptive material.

In a second aspect, a method of making a coated microstructured film according to the first aspect is provided. The method comprises a) obtaining a microstructured film comprising a plurality of microstructures extending across a first surface of the microstructured film and b) applying a coating comprising one or more polyelectrolytes to at least some of the microstructures across the first surface of the microstructured film. The coating has an average thickness T and is essentially free of any light absorptive material. The method further comprises c) removing at least a portion of the coating from a second portion of the coated microstructures to provide the coating disposed on a first portion of the coated microstructures.

In a third aspect, a method of making a light control film is provided. The method comprises a) obtaining a microstructured film comprising a plurality of microstructures extending across a first surface of the microstructured film: b) applying a coating comprising one or more polyelectrolytes to at least some of the microstructures across the first surface of the microstructured film, the coating having an average thickness T; and c) removing at least a portion of the coating from a second portion of the coated microstructures to provide the coating disposed on a first portion of the coated microstructures, thereby forming a coated microstructured film. The method further comprises d) either i) infusing a light absorptive material into the coating of the coated microstructured film or ii) applying a layer of a pigment on the coating. The light control film exhibits a transmission of visible light of 75% or greater at a viewing angle of 0 degrees.

Typically, louver-based privacy and angular light control films primarily employ light-absorbing, broadband pigments (e.g., carbon black) in their structures. For certain applications, however, there may be very specific wavelength-selectivity desired. Such applications could be for small-volume applications (e.g., wearable sensors). Films and methods according to at least embodiments of the present disclosure solve the problem of needing a customizable microstructured film to which can be added or incorporated light-absorbing materials (e.g., by post-infusion or coating with one or more dyes and/or pigments) to achieve a desired wavelength-selectivity. Rolls of the customizable louver films can be made with the same materials, and then sections may be post-processed and customized for the smaller volume applications, for example.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1A is a flow chart of exemplary methods according to the present disclosure.

FIG. 1B is a cross-sectional schematic illustration of an exemplary method of making a coated microstructured film and a light control film.

FIG. 2A is a schematic perspective view of a microstructured film having a plurality of ribs alternating with channels.

FIG. 2B is a schematic cross-sectional view of a microstructured film having a plurality of ribs alternating with channels.

FIG. 3A is a schematic cross-sectional view of a microstructured film having a plurality of facets and sidewalls each meeting at a ridge of the microstructure.

FIG. 3B is a schematic cross-sectional view of a microstructured film that is a linear prism.

FIG. 3C is a schematic cross-sectional view of a microstructured film that is a linear Fresnel element.

FIG. 4A is a schematic cross-sectional view of a microstructured film that has a two-dimensional array of projections.

FIG. 4B is a top plan view of four representative engineered micropatterned regions for a two-dimensional array of projections.

FIG. 5A is a schematic cross-sectional view of a microstructured film having a plurality of cavities extending between two major surfaces.

FIG. 5B is generalized schematic exploded view of a microstructured film having a plurality of cavities extending between two major surfaces.

While the above-identified figures set forth various embodiments of the disclosure, other embodiments are also contemplated, as noted in the description. In all cases, this disclosure presents the invention by way of representation and not limitation. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

### Glossary

As used herein, “microstructures” refer to engineered elements having at least two feature dimensions that are microscopic, namely 1 micrometer to less than 1000 micrometers.

As used herein, “engineered” with respect to microstructures refers to surface features that were created from a specific design with deterministic position, size, shape, spacing, and dimensions.

As used herein, the term “essentially free” in the context of a composition being essentially free of a component, refers to a composition containing less than 1% by weight (wt. %), 0.5 wt. % or less, 0.25 wt. %, 0.1 wt. %, 0.05 wt. %, 0.001 wt. %, or 0.0001 wt. % or less of the component, based on the total weight of the composition; or less than 1% by volume (vol. %), 0.5 vol. % or less, 0.25 vol. %, 0.1 vol. %, 0.05 vol. %, 0.001 vol. %, or 0.0001 vol. % or less of the component, based on the total volume of the composition. The term “essentially free” in the context of a composition being essentially free specifically of any light absorptive material refers to the composition exhibiting a maximum absorbance of no more than 0.10 at a wavelength of interest, typically from 400 nanometers to 1500 nanometers. The term “essentially free” in the context of a feature of a structure (e.g., a surface of a layer), refers to a structure having less than 5% by area of the component, 4% or less, 3%, 2%, or 1% or less by area of the component, based on the total area of the structure.

As used herein, “facet” refers to a flat or curved planar surface.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, a coated microstructured film is provided. The coated microstructured film comprises:
a) a plurality of microstructures extending across a first surface of the microstructured film; and
b) a coating disposed on a first portion of at least some of the microstructures, the coating comprising one or more polyelectrolytes, the coating having an average thickness T, wherein a second portion of the coated microstructures either lacks the coating or comprises the coating disposed thereon having an average thickness of no more than 50% of T; wherein the coating is essentially free of any light absorptive material.

In a second aspect, a method of making a coated microstructured film according to the first aspect is provided. The method comprises:
a) obtaining a microstructured film comprising a plurality of microstructures extending across a first surface of the microstructured film;
b) applying a coating comprising one or more polyelectrolytes to at least some of the microstructures across the first surface of the microstructured film, the coating having an average thickness T, wherein the coating is essentially free of any light absorptive material; and
c) removing at least a portion of the coating from a second portion of the microstructures to provide the coating disposed on a first portion of the microstructures.

The first and second aspects are described in detail below.

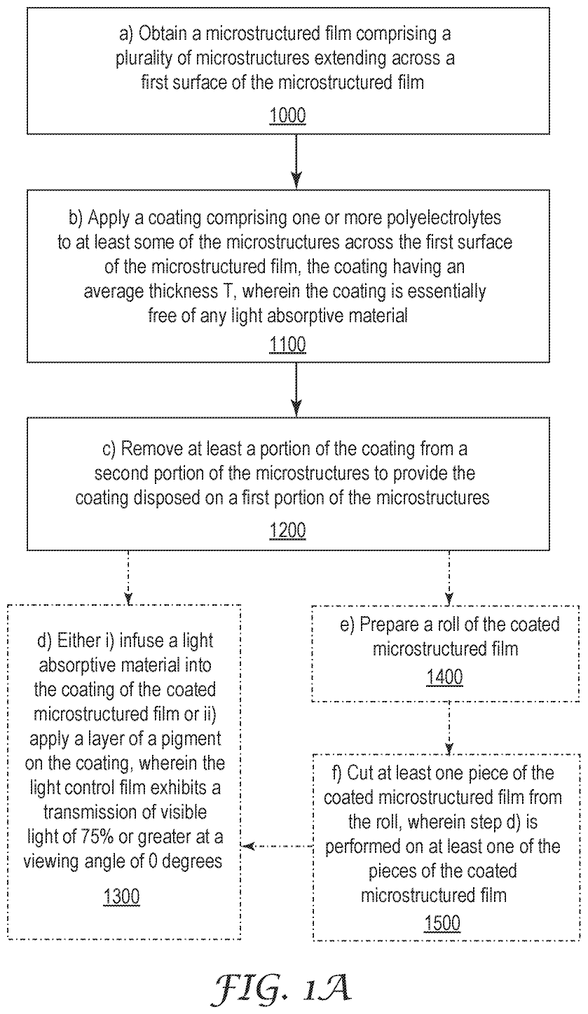

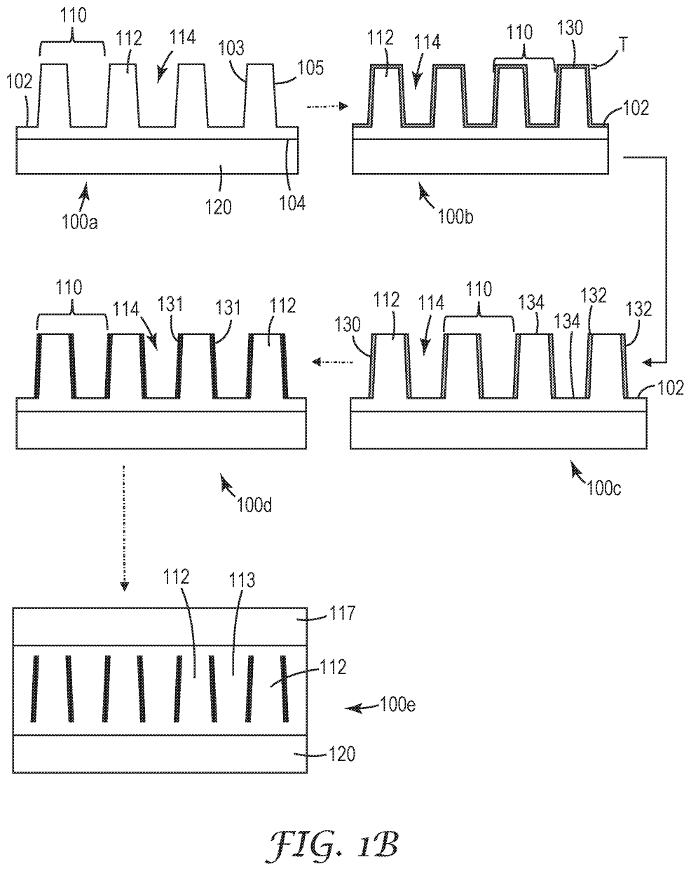

Referring to FIG. 1A, methods according to the present disclosure include Step 1000 to a) obtain a microstructured film comprising a plurality of microstructures extending across a first surface of the microstructured film and Step 1100 to b) apply a coating comprising one or more polyelectrolytes to at least some of the microstructures across the first surface of the microstructured film, the coating having an average thickness T, wherein the coating is essentially free of any light absorptive material. Step 1200 is further included, to c) remove at least a portion of the coating from a second portion of the microstructures to provide the coating disposed on a first portion of the microstructures.

Referring to FIG. 1B, a cross-sectional schematic illustration is provided of an exemplary method of making a coated microstructured film. More particularly, to start, FIG. 1B shows a microstructured film 100a having a plurality of microstructures 110 extending across a first (e.g., major) surface 102 of the microstructured film 100a. In this particular embodiment, the microstructures 110 comprise a plurality of ribs 112 alternated with channels 114. Optionally, a substrate 120 is adjacent to a second (e.g., major) surface 104 of the microstructured film 100a. Next, FIG. 1B shows a microstructured film 100b comprising a coating 130 that has been applied to the microstructures 110 across the first surface 102 of the microstructured film 100b.

The coating (e.g., layer) on the first portion of microstructures comprises one or more polyelectrolytes. The coating is typically deposited by the layer-by-layer (LbL) assembly process. This process is commonly used to assemble films or coatings of oppositely charged polyelectrolytes electrostatically, but other functionalities such as hydrogen bond donor/acceptors, metal ions/ligands, and covalent bonding moieties can be the driving force for film assembly. “Polyelectrolyte” means a polymer or compound with multiple ionic groups capable of electrostatic interaction, e.g., cationic functional groups and anionic functional groups. “Strong polyelectrolytes” possess permanent charges across a wide range of pH (e.g., polymers containing quaternary ammonium groups or sulfonic acid groups). In certain cases, the polyelectrolytes preferably comprise polymers containing such strong polyelectrolytes.

Besides strong polyelectrolyte coatings, it is also possible to use weak polyelectrolyte coatings, which can be tuned by pH. “Weak polyelectrolytes” possess a pH-dependent level of charge (e.g., polymers containing primary, secondary, or tertiary amines, or carboxylic acids, or phosphonic acids). In certain cases, the polyelectrolytes preferably comprise polymers containing such weak polyelectrolytes. Further, a surface of the coating optionally exhibits a positive zeta potential at a pH in the range of 1-14. Surface zeta potential can be measured by a streaming potential analyzer, also known as an electrokinetic analyzer, available commercially from Anton-Paar USA (Ashland, VA), for example.

Suitable polymers that include a plurality of positively charged ionic (or ionizable) groups (i.e., polycationic polymers) can be derived from these monomers, for example:
Primary amino-containing monomers and their salts (e.g., hydrochloride salts): vinyl amine, allyl amine, aminoalkyl (meth)acrylamide, aminoalkyl (meth)acrylate, 2-N-morpholinoalkyl (meth)acrylate
Secondary amino-containing monomers and their salts (e.g., hydrochloride salts): alkylaminoalkylene (meth)acrylates such as, for example, 2-(methylamino)ethyl (meth)acylate
Tertiary amino-containing monomers and their salts (e.g., hydrochloride salts): various N,N-dialkylaminoalkyl (meth)acrylates and N,N-dialkylaminoalkyl (meth)acrylamides such as N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide, (tert-butylamino)alkyl methacrylate, (tert-butylamino)alkyl methacrylamide
Quaternary amino-containing monomers: methacryloylaminopropyl trimethylammonium chloride, diallyldimethylammonium chloride, 2-acryloxyalkyltrimethylammonium chloride

Some of the more common polycationic polymers used for layer-by-layer coating are: linear and branched poly(ethylenimine) (PEI), poly(allylamine hydrochloride), polyvinylamine, chitosan, polyaniline, polyamidoamine, poly(vinylbenzyltrimethylamine), polydiallyldimethylammonium chloride (PDAC), poly(dimethylaminoethyl methacrylate), poly [(3-methacryloylamino) propyl]-trimethylammonium chloride, and combinations thereof including copolymers thereof.

Suitable polycations may also include polymer latexes, dispersions, or emulsions with positively charged functional groups on the surface. Examples include Sancure 20051 and Sancure 20072 cationic polyurethane dispersions available from Lubrizol Corporation (Wickliffe, OH). Suitable polycations may also include inorganic nanoparticles (for example, aluminum oxide, zirconium oxide, titanium dioxide) suitably below their native isoelectric point, or alternatively surface-modified with positively charged functional groups.

Suitable polymers that include negatively charged ionic (or ionizable) groups (i.e., polyanionic polymers) can be derived from these monomers (and salts thereof), for example: Acid monomers: (meth)acrylic acid, β-carboxyethyl (meth)acylate, 2-(meth)acryloyloxyethyl phthalic acid, 2-(meth)acryloyloxy succinic acid, vinyl phosphonic acid, vinyl sulfonic acid, styrene sulfonic acid, and 2-acrylamido-2-methylpropane sulfonic acid, (meth)acrylate salts (i.e., zinc acrylate, zirconium acrylate, etc.), carboxyethyl (meth)acrylate salts (i.e., zirconium carboxyethyl acrylate), 2-sulfoalkyl (meth)acrylate, phosphonoalkyl (meth)acrylate, phosphoric acid 2-hydroxyethyl methacrylate ester.

Some of the more common polyanionic polymers used for layer-by-layer coating are: poly(vinyl sulfate), poly(vinyl sulfonate), poly(acrylic acid) (PAA), poly(methacrylic acid), poly(styrene sulfonate), dextran sulfate, heparin, hyaluronic acid, carrageenan, carboxymethylcellulose, alginate, sulfonated tetrafluoroethylene based fluoropolymers such as Nafion R, poly(vinylphosphoric acid), poly(vinylphosphonic acid), and combinations thereof including copolymers thereof.

Suitable polyanions may also include polymer latexes, dispersions, or emulsions with negatively charged functional groups on the surface. Such polymers are available, for example, under the JONCRYL tradename (BASF, Florham Park, NJ), CARBOSET tradename (Lubrizol Corporation), and NEOCRYL tradename (DSM Coating Resins, Wilmington, MA). Suitable anions may also include inorganic nanoparticles (for example, silicon oxide, aluminum oxide, zirconium oxide, titanium dioxide, nano-clay) suitably above their native isoelectric point, or alternatively surface-modified with negatively charged functional groups.

The molecular weight of the polyelectrolyte polymers can vary, typically ranging from about 1,000 g/mole to about 1,000,000 g/mole. In some embodiments, the weight average molecular weight (Mw) of the negatively charged anionic layer ranges from 50,000 g/mole to 150,000 g/mole. In some embodiments, the weight average molecular weight (Mw) of the positively charged cationic layer ranges from 50,000 g/mole to 300,000 g/mole or from 10,000 g/mole to 50,000 g/mole.

Typically, the polyelectrolyte is prepared and applied to the microstructured surface as an aqueous solution. The term “aqueous” means that the liquid of the coating contains at least 85 percent by weight of water. It may contain a higher amount of water such as, for example, at least 90, 95, or even at least 99 percent by weight of water or more. The aqueous liquid medium may comprise a mixture of water and one or more water-soluble organic cosolvent(s), in amounts such that the aqueous liquid medium forms a single phase. Examples of water-soluble organic cosolvents include methanol, ethanol, isopropanol, 2-methoxyethanol, 3-methoxypropanol, 1-methoxy-2-propanol, tetrahydrofuran, and ketone or ester solvents. The amount of organic cosolvent typically does not exceed 15 wt. % of the total liquids of the coating composition. The aqueous polyelectrolyte composition for use in layer-by-layer self-assembly typically comprises at least 0.01 wt. %, 0.05 wt. % or 0.1 wt. % of polyelectrolyte and typically no greater than 5 wt. %, 4 wt. %, 3 wt. %, 2 wt. % or 1 wt. %.

In some embodiments, the aqueous solutions further comprise a “screening agent”, an additive that promotes even and reproducible deposition by increasing ionic strength and reducing interparticle electrostatic repulsion. In the case of aqueous solutions comprising soluble polyelectrolytes, the screening agents can change the conformation of the polymer chains, thereby altering the thickness of the resulting coating as well as the degree of intrinsic versus extrinsic charge compensation. Intrinsic charge compensation occurs when a positively charged functional group on one material (e.g., polymer) is charge neutralized by a negatively charged functional group on another material (e.g., polymer). Extrinsic charge compensation occurs when a charged functional group on a material (e.g., polymer) is charge neutralized by a small counterion (e.g., a positively charged functional group neutralized by a chloride ion, or a negatively charged functional group neutralized by a sodium ion). Suitable screening agents include any low molecular weight salts such as halide salts, sulfate salts, nitrate salts, phosphate salts, fluorophosphate salts, and the like. Examples of halide salts include chloride salts such as LiCl, NaCl, KCl, CaCl₂), MgCl₂, NH₄Cl and the like, bromide salts such as LiBr, NaBr, KBr, CaBr₂, MgBr₂, and the like, iodide salts such as LiI, NaI, KI, CaI₂, MgI₂, and the like, and fluoride salts such as, NaF, KF, and the like. Examples of sulfate salts include Li₂SO₄, Na₂SO₄, K₂SO₄, (NH₄)₂SO₄, MgSO₄, CoSO₄, CuSO₄, ZnSO₄, SrSO₄, Al₂(SO₄)₃, and Fe₂(SO₄)₃. Organic salts such as (CH₃)₃CCl, (C₂H₅)₃CCl, and the like are also suitable screening agents. Suitable screening agent concentrations can vary with the ionic strength of the salt. In some embodiments, the aqueous solution comprises (e.g. NaCl) screening agent at a concentration ranging from 0.01 M to 2 M.

Typically, this LbL deposition process involves exposing the substrate (e.g., microstructured film) having a surface charge, to a series of liquid solutions, or baths. This can be accomplished by immersion of the substrate into liquid baths (also referred to as dip coating), spraying, spin coating, roll coating, inkjet printing, and the like. Exposure to the first polyion (e.g., polyelectrolyte bath) liquid solution, which has charge opposite that of the substrate, results in charged species near the substrate surface adsorbing quickly, establishing a concentration gradient, and drawing more polyelectrolyte from the bulk solution to the surface. Further adsorption occurs until a sufficient layer has developed to mask the underlying charge and reverse the net charge of the substrate surface. In order for mass transfer and adsorption to occur, this exposure time is typically on the order of seconds to minutes. The substrate is then removed from the first polyion (e.g., bath) liquid solution, and is then exposed to a series of water rinse baths to remove any physically entangled or loosely bound polyelectrolyte. Following these rinse (e.g., bath) liquid solutions, the substrate is then exposed to a second polyion liquid solution, which has charge opposite that of the first polyion (e.g., bath) liquid solution. Once again adsorption occurs, since the surface charge of the substrate is opposite that of the second (e.g., bath) liquid solution. Continued exposure to the second polyion (e.g., bath) liquid solution then results in a reversal of the surface charge of the substrate. A subsequent rinsing can be performed to complete the cycle. This sequence of steps is said to build up one layer pair, also referred to herein as a “bi-layer” of deposition and can be repeated as desired to add further layer pairs to the substrate. In one embodiment, the plurality of layers deposited by layer-by-layer assembly is a polyelectrolyte stack comprising an organic polymeric polyion (e.g., cation) and an organic polymeric counterion (e.g., anion). Optionally, a single monolayer of a charged material, i.e., one half bi-layer, may be employed as the coating on the microstructures. A monolayer may typically have an average thickness in the range of 0.1 nm to 5 nm for soluble polymers and 5 nm to 100 nm for polymer dispersions.

Some examples of suitable processes include those described in Krogman et al., U.S. Pat. No. 8,234,998; Hammond-Cunningham et al., US2011/0064936; and Nogueira et al., U.S. Pat. No. 8,313,798. Layer-by layer dip coating can be conducted using a StratoSequence VI (nanoStrata Inc., Tallahassee, FL) dip coating robot.

From a practical perspective, it is possible that not every LbL process will result in 100% of the microstructures having a layer of coating disposed on their surfaces. At least 10% of the microstructures comprise the coating, 15% or greater, 20%, 25%, 30%, 35%, 40%, 45%, 50%, 55%, 60%, 65%, 70%, 75%, 80%, 82%, 84%, 86%, 88%, 90%, 92%, 94%, 96% or 98% or greater of the microstructures comprise the coating.

FIG. 1B additionally shows a microstructured film 100c from which a portion of the coating 130 has been removed from a second portion 134 of the microstructures 110 to provide the coating 130 on a first portion 132 of the microstructures 110. As is apparent from the illustration, each of the first portion 132 of the microstructures 110 and the second portion 134 of the microstructures is a discontinuous portion. Typically, individual regions of the first portion of microstructures and of the second portion of microstructures will alternate with each other over the first surface of the microstructured film (e.g., a first portion including rib sidewalls and a second portion including rib tops and channel bottom surfaces).

In general, the coating is either significantly thinner or substantially not present on certain surfaces (i.e., the second portion) of the microstructures than others (i.e., the first portion). Often, the second portion of the coated microstructures includes the coating (e.g., a layer) disposed therein having an average thickness of no more than 45%, 40%, 35%, 30%, 25%, 20%, 15, or 10% of T. In some cases, the average thickness T is 0.1 nanometers (nm) or greater, 0.2 nm, 0.3 nm, 0.4 nm, 0.5 nm, 0.6 nm, 0.7 nm, 0.8 nm, 0.9 nm, 1 nm, 2 nm, 3 nm, 4 nm, 5 nm, 6 nm, 7 nm, 8 nm, 9 nm, 10 nm, 11 nm, 12 nm, 13 nm, 14 nm, or 15 nm or greater; and 5 micrometers or less, 4.75 micrometers, 4.5 micrometers, 4.25 micrometers, 4 micrometers, 3.75 micrometers, 3.5 micrometers, 3.25 micrometers, 3 micrometers, 2.75 micrometers, 2.5 micrometers, 2.25 micrometers, 2 micrometers, 1.75 micrometers, 1.5 micrometers, 1.25 micrometers, 1 micrometer, 900 nm, 800 nm, 700 nm, 600 nm, 500 nm, 400 nm, 300 nm, 200 nm, 100 nm, 90 nm, 80 nm, 70 nm, 60 nm, or 50 nm or less. Stated another way, the average thickness T may range from 0.1 nanometers to 5 micrometers. Average thickness can be determined, for instance, by taking the average of 3 thickness measurements across the second portion, in which the thickness measurements are made by scanning electron microscopy (SEM) of a cross-section of the microstructured film.

It is to be understood that following coating and removal of areas/thicknesses of the coating, the resulting coated microstructured film is likely to have minor variabilities in the coverage of the first portion of the microstructured surface depending on the precision of the coating and selective removal processes. Accordingly, it is possible that less than 100% of the surfaces of the first portion of the microstructured film may be covered, e.g., at least 10% of the surfaces of the first portion of the microstructured film are covered, 15% or greater, 20%, 25%, 30%, 35%, 40%, 45%, 50%, 55%, 60%, 65%, 70%, 75%, 80%, 82%, 84%, 86%, 88%, 90%, 92%, 94%, 96% or 98% or greater of the surfaces of the first portion of the microstructured film are covered.

Any suitable method can be used to selectively remove the coating (e.g., layer) from the second portion of the microstructures. In one embodiment, the coating is removed by reactive ion etching. Reactive ion etching (RIE) is a directional etching process utilizing ion bombardment to remove material. RIE systems are used to remove organic or inorganic material by etching surfaces orthogonal to the direction of the ion bombardment. The most notable difference between reactive ion etching and isotropic plasma etching is the etch direction. Reactive ion etching is characterized by a ratio of the vertical etch rate to the lateral etch rate which is greater than 1. Systems for reactive ion etching are built around a durable vacuum chamber. Before beginning the etching process, the chamber is evacuated to a base pressure lower than 1 Torr, 100 mTorr, 20 mTorr, 10 mTorr, or 1 mTorr. An electrode bolds the materials to be treated and is electrically isolated from the vacuum chamber. The electrode may be a rotatable electrode in a cylindrical shape. A counter electrode is also provided within the chamber and may be comprised of the vacuum reactor walls. Gas comprising an etchant enters the chamber through a control valve. The process pressure is maintained by continuously evacuating chamber gases through a vacuum pump. The type of gas used varies depending on the etch process. Carbon tetrafluoride (CF₄), sulfur hexafluoride (SF₆)·octafluoropropane (C₃F₈), fluoroform (CHF₃), boron trichloride (BCl₃), hydrogen bromide (HBr), chlorine, argon, and oxygen are commonly used for etching. RF power is applied to the electrode to generate a plasma Samples can be conveyed on the electrode through plasma for a controlled time period to achieve a specified etch depth. Reactive ion etching is known in the art and further described in U.S. Pat. No. 8,460,568 (David et al.); incorporated herein by reference.

In some embodiments, reactive ion etching may result in the coating being thinner near the bottom surface of a microstructure. Removing the coating can result in a (e.g., slight) increase in the depth of a channel or base layer of the microstructured film.

From a practical perspective, it is possible that not every removal process will result in removing some or all of the coating from the second portion of 100% of the microstructures having a layer of coating disposed on their surfaces. Accordingly, in some cases 5% or more of the microstructures have none of the coating removed from their second portion, such as 7% or more, 9%, 10%, 12%, 15% or more; and 20% or less of the microstructures have none of the coating removed from their second portion.

### Microstructured Films

### Louver Structure

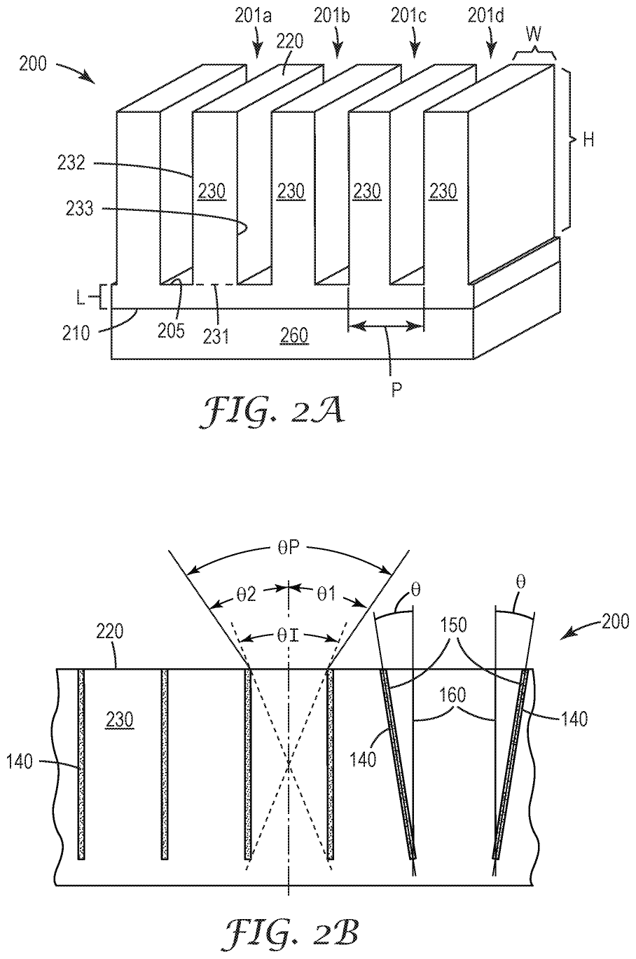

FIG. 2A shows an embodied microstructured film 200 having a louver structure, which can be coated to make a coated microstructured film according to the present disclosure. The depicted microstructured film 200 includes a microstructured surface 210 comprising a plurality of channels 201a-201d on base layer 260. As shown in FIG. 2A, a continuous land layer “L” can be present between the bottom of the channels 205 and the top surface 210 to base layer 260. Alternatively, the channels 201 can extend all the way through the microstructured film article 200. In some cases (not shown), the bottom surface 205 of the groove can be coincident with the top surface 210 of a base layer 260. In typical embodiments, the base layer 260 is a preformed film that comprises a different organic polymeric material than the ribs 230.

The height and width of ribs (e.g., protrusions) 230 are defined by adjacent channels (e.g., 201a and 201b). The ribs 230 can be defined by a top surface 220, a bottom surface, 231, and side walls 232 and 233 that join the top surface to the bottom surface. The side walls can be parallel to each other. More typically the side walls have a wall angle.

The ribs 230 can be defined by a width “W”. Often, the ribs have a width parallel to the first surface of the microstructured film and a height orthogonal to the first surface of the microstructured film. Excluding the land region “L”, the ribs 230 typically have nominally the same height as the channels 201. In typical embodiments, the height “H” of the channels 201 and/or the ribs 230 is at least 10, 20, 30, 40, 50, 60, 70, 80, 90 or 100 micrometers. In some embodiments, the height is no greater than 250, 240, 230, 220, 210, 200, 190, 180, 170, 160, 150, 140, 130, 120, 110, or 100 micrometers. In some embodiments, the height of the channels 201 and/or the ribs 230 ranges from 50 to 250 micrometers. The microstructured film typically comprises a plurality of ribs 230 having nominally the same height and width. In some embodiments, the ribs 230 have a height, “H”, a maximum width at its widest portion, “W”, and an aspect ratio, H/W, of at least 1.5. In some embodiments, H/W is at least 1.75, 2.0, 2.25, 2.5, 2.75, 3.0, 3.5, 4.0, 4.5 or 5.0. In other embodiments, the aspect ratio of the ribs is at least 6, 7, 8, 9, or 10. In other embodiments, the aspect ratio of the ribs is at least 15, 20, 25, 30, 35, 40, 45, or 50.

Channels 201 have a height “H” defined by the distance between the bottom surface 205 and top surface 220, such top and bottom surfaces typically being parallel to the top surface 210 of a base layer 260. The channels 201 have a maximum width “W” and are spaced apart along microstructured surface 210 by a pitch “P”. The width of the channels “W”, at the base (i.e., adjacent to bottom surface 205) is typically nominally the same as the width of the channels adjacent the top surface 220. However, when the width of the channels at the base differs from the width adjacent the top surface, the width is defined by the maximum width. The maximum width of a plurality of channels can be averaged for an area of interest, such as an area in which visible light transmission is measured. The microstructured film typically comprises a plurality of channels having nominally the same height and width. In typical embodiments, the channels generally have a width no greater than 50, 40, 30, 20, 10, 9, 8, 7, 6, 5, 4, 3, 2, or 1 micrometer. In some embodiments, the channels generally have a width no greater than 900, 800, 700, 600, or 500 nanometers. In some embodiments, the channels have a width of at least 50, 60, 70, 80, 90, or 100 nanometers.

As shown in FIG. 2B, a microstructured film 200 includes alternating ribs 230 and channels 201, and an interface 150 between ribs 230 and channels 201. Interface 150 forms a wall angle θ with line 160 that is perpendicular to first surface 220 of the microstructured film 200. Larger wall angles θ decrease light transmission (following dye infusion or pigment adsorption) at normal incidence or in other words a viewing angle of 0 degrees. Smaller wall angles are preferred such that the transmission of light at normal incidence can be made as large as possible. In some embodiments, the wall angle θ is less than 10, 9, 8, 7, 6, 5, 4, 3, 2, 1, or 0.1 degrees. In some embodiments, the wall angle is no greater than 2.5, 2.0. 1.5, 1.0, 0.5, or 0.1 degrees. In some embodiments, the wall angle is zero or approaching zero. When the wall angle is zero, the angle between the channels and first surface 220 is 90 degrees. Depending on the wall angle, the ribs can have a rectangular or trapezoidal cross-section. In some embodiments, the side walls can be described as comprising first and second side walls, in which the first side wall has a wall angle with a line that is perpendicular to the first surface of the microstructured film from 0 degrees to +10 degrees or from 0 degrees to −10 degrees relative to the bottom surface of the microstructured film.

In some embodiments, the ribs 230 have a pitch, “P” of at least 10 micrometers. The pitch is the distance between the onset of a first rib and the onset of a second rib as depicted in FIG. 2A. The pitch may be at least 15, 20, 25, 30, 35, 40, 45, 50, 60, or 70 micrometers. The pitch is generally no greater than 1 mm. The pitch is typically no greater than 900, 800, 700, 600, or 500 micrometers. In some embodiments, the pitch is typically no greater than 550, 500, 450, 400, 350, 300, 250 or 200 micrometers. In some embodiments, the pitch is no greater than 175, 150, 100 micrometers. In typical embodiments, the ribs are evenly spaced, having a single pitch. Alternatively, the ribs may be spaced such that the pitch between adjacent ribs is not the same. In this later embodiment, at least some and typically the majority (at least 50, 60, 70, 80, 90% or greater of the total ribs) have the pitch just described. The pitch of the channels is within the same range as just described for the ribs. Optionally, the channels have an average pitch of 10 to 200 micrometers. The pitch and height of the ribs can be important to facilitate coating of the ribs with a coating. When the ribs are spaced too close together it can be difficult to uniformly coat the side walls. When the ribs are spaced too far apart, the coating may not be effective at providing its intended functions.

A louver structure can be prepared by any suitable method. In one embodiment, a structure, e.g., the microstructured film 200 shown in FIG. 2A, can be prepared by a method including the steps of (a) preparing a polymerizable composition: (b) depositing the polymerizable composition onto a master negative microstructured molding surface (e.g., tool) in an amount barely sufficient to fill the cavities of the master; (c) filling the cavities by moving a bead of the polymerizable composition between a (e.g., preformed film) base layer and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions and has a surface energy that allows clean removal of the polymerized material from the master. When the base layer is a preformed film, one or more of the surfaces of the film can optionally be primed or otherwise be treated to promote adhesion to the organic material of the microstructure.

The polymerizable resin can comprise a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition can comprise a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

The polymerizable resin can be a radiation curable polymeric resin, such as a UV curable resin. In some cases, polymerizable resin compositions useful for the microstructured film of the present disclosure can include polymerizable resin compositions such as are described in U.S. Pat. No. 8,012,567 (Gaides et al.).

The chemical composition and thickness of the base layer can depend on the end use of the microstructured film. In typical embodiments, the thickness of the base layer can be at least about 0.025 millimeters (mm) and can be from about 0.05 mm to about 0.25 mm. Useful base layer materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefin-based material such as cast or orientated films of polyethylene, polypropylene, and polycyclo-olefins, polyimides, and glass. Optionally, the base layer can contain mixtures or combinations of these materials. In some embodiments, the base layer may be multi-layered or may contain a dispersed component suspended or dispersed in a continuous phase.

Examples of base layer materials include polyethylene terephthalate (PET) and polycarbonate (PC). Examples of useful PET films include photograde polyethylene terephthalate, available from DuPont Films (Wilmington, DE) under the trade designation “Melinex 618”. Examples of optical grade polycarbonate films include LEXAN polycarbonate film 8010, available from GE Polymershapes, Seattle, WA, and Panlite 1151, available from Teijin Kasei, Alpharetta, GA.

Alternatively, the microstructured film 200 can be prepared by melt extrusion, i.e., casting a fluid resin composition onto a master negative microstructured molding surface (e.g., tool) and allowing the composition to harden. In this embodiment, the ribs 230 are interconnected in a continuous layer to base layer 260. The individual ribs and connections therebetween generally comprise the same thermoplastic material. The thickness of the land layer (i.e., the thickness excluding that portion resulting from the replicated microstructure) is typically between 0.001 and 0.100 inches and preferably between 0.003 and 0.010 inches. Suitable resin compositions for melt extrusion are transparent materials that are dimensionally stable, durable, weatherable, and readily formable into the desired configuration. Examples of suitable materials include acrylics, which have an index of refraction of about 1.5, such as Plexiglas brand resin manufactured by Rohm and Haas Company (Philadelphia, PA); polycarbonates, which have an index of refraction of about 1.59; reactive materials such as thermoset acrylates and epoxy acrylates; polyethylene based ionomers, such as those marketed under the brand name of SURLYN by Dow Chemical (Midland, MI); (poly)ethylene-co-acrylic acid; polyesters; polyurethanes; and cellulose acetate butyrates. Polycarbonates are particularly suitable because of their toughness and relatively higher refractive index.

In yet another embodiment, the master negative microstructured molding surface (e.g., tool) can be employed as an embossing tool, such as described in U.S. Pat. No. 4,601,861 (Pricone).

Further details regarding microstructured films having such louver structures and how to form them are described in WO 2019/118685 (Schmidt et al.) and WO 2020/026139 (Schmidt et al.), each incorporated herein by reference.

### Facet Structure

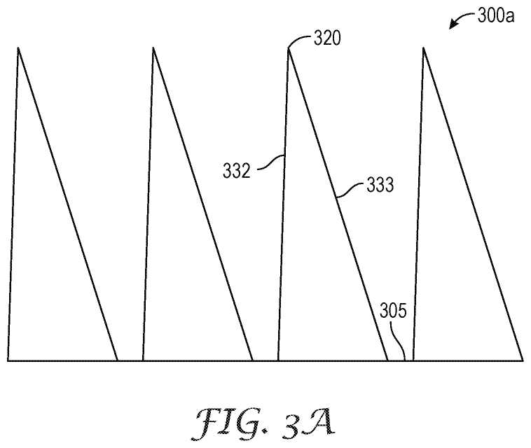

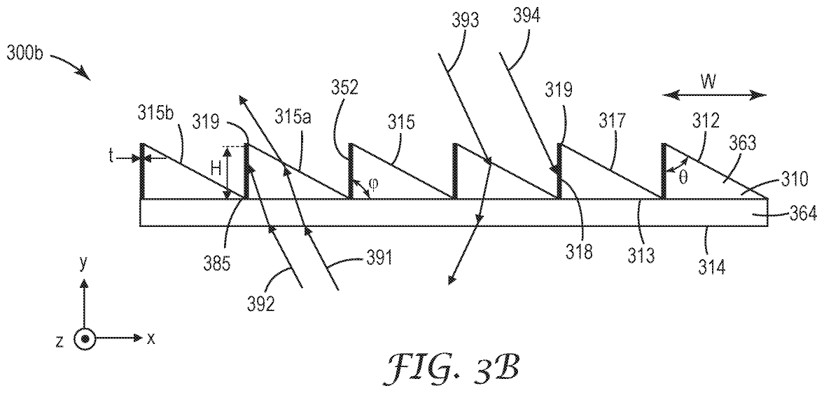

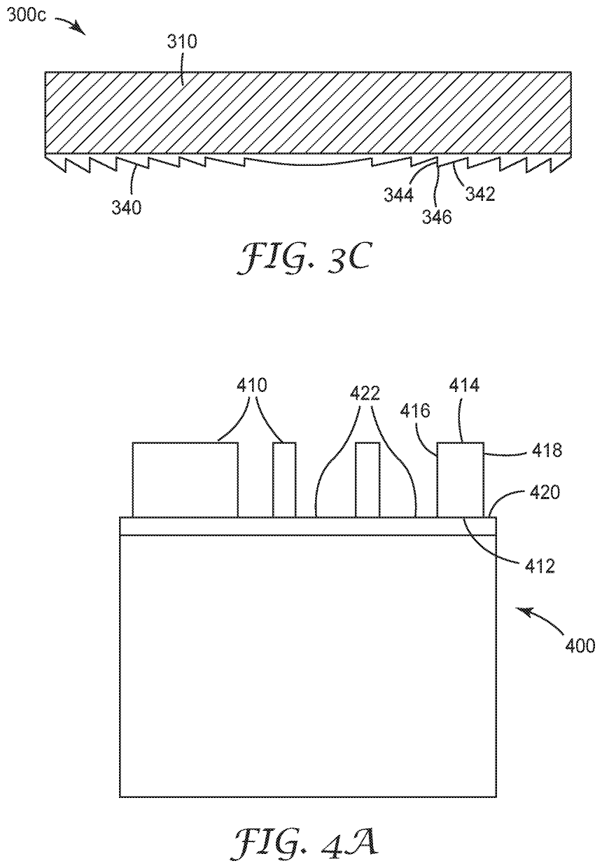

FIG. 3A shows an embodied microstructured film 300a having a facet structure, which can be coated to make a coated microstructured film according to the present disclosure. More particularly, FIG. 3A illustrates a microstructured film 300a defining bottom surfaces 305, top surfaces 320, first sidewalls 332 and facets 333. Stated another way, the microstructures comprise a facet 333 and a side wall 332 meeting the facet 333 at a ridge 320 of the microstructure. The facet 333 and the side wall 332 typically define an oblique angle therebetween. When such a facet structure is used in a coated microstructured film, the first portion on which the coating (not shown) is disposed comprises the side wall 332 and the second portion comprises the facet 333 and the bottom surface 305. Further details regarding microstructured films having such facet structures and how to form them are described in WO 2020/250180 (Kenney et al.), incorporated herein by reference.

In some microstructured films including a facet structure, each of the microstructures is a linear prism having a substantially same angle between the optical facet and the side wall, or a linear Fresnel element.

Referring to FIG. 3B, a schematic cross-sectional view is provided of a microstructured film 300b comprising a linear prism. The microstructured film 300b can include opposing first 312 and second 314 major surfaces where the first major surface 312 includes a plurality of microstructures 315. The microstructures 315 have a width W that is typically less than 1 mm. The width W and/or the height H can be the same for different microstructures. In this embodiment, the plurality of microstructures 315 includes a plurality of linear prisms for redirecting light where each prism has a substantially same geometry (e.g., the angle θ can be a same angle for each prism).

Each microstructure 315 includes a facet 317 and a sidewall 318 meeting the facet 317 at a ridge 319 of the microstructure. The facet 317 and the sidewall 318 define an oblique angle θ therebetween. In some embodiments, the oblique angle θ is at least 20 degrees or at least 30 degrees and is no more than 80 degrees or no more than 70 degrees. When such a linear prism facet structure is used in a coated microstructured film, the first portion on which the coating 352 is disposed comprises the sidewall 318 and the second portion comprises the facet 317. The microstructured film 300b may also have a polymeric layer 310, which may include a polymeric structured layer 363 formed on a substrate layer 364 (e.g., a polymeric substrate).

Referring to FIG. 3C, a schematic cross-sectional view is provided of a microstructured film 300c comprising a Fresnel element. Microstructured film 300c comprises a polymeric layer 310 and a plurality of microstructures 340. Each microstructure 340 includes a facet 342 and a sidewall 344 meeting the facet 342 at a ridge 346 of the microstructure 340. The facet 342 and the side wall 344 typically define an oblique angle therebetween. Unlike the linear prism microstructures shown in FIG. 3B, however, the Fresnel element includes microstructures 340 that have a varying geometry (e.g., the angle can vary from a center of the microstructured film 300c to an edge of the microstructured film 300c), typically selected to produce a desired optical effect. Further, the width and/or the height can be different for different microstructures. When such a Fresnel element facet structure is used in a coated microstructured film, the first portion on which the coating (not shown) is disposed comprises the side wall 344 and the second portion comprises the facet 342.

Further details regarding microstructured films having such linear prism and Fresnel element structures and how to form them are described in WO 2021/090130 (Liu et al.) and US 2012/0204566 (Hartzell et al.), each incorporated herein by reference.

### Projection Array Structure

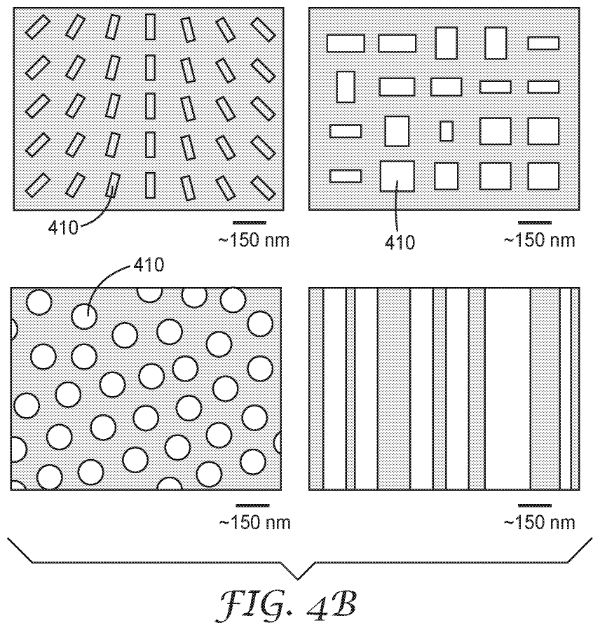

FIG. 4A shows an embodied microstructured film 400 having a projection array structure, which can be coated to make a coated microstructured film according to the present disclosure. More particularly, FIG. 4A is a schematic cross-sectional view of a microstructured film 400 that has a two-dimensional (x- and y-axes) array of projections 410 arranged across a first surface 420. Each of the projections 410 comprises a base 412, a top 414, and one or more sides 416, 418 connecting the top to the base. Optionally, each of the projections 410 is a spaced-apart post. For instance, FIG. 4B is a top plan view of four representative engineered micropatterned regions for a two-dimensional array of projections, including spaced-apart posts 410 present in all but the lower right image. Some microstructured surfaces may comprise projections with a range of aspect ratio values, such as an array of projections with constant height and variable width. In such cases, the surface is usually characterized by the largest aspect ratio value.

When such a projection array structure is used in a coated microstructured film, the first portion on which the coating (not shown) is disposed comprises the sides 416 and 418 and the second portion comprises the top 414. Further, when the each of the projections 410 is a spaced-apart post, the second portion also comprises a surface 422 of the microstructured film 400 between the spaced-apart posts (i.e., projections 410).

Further details regarding microstructured films having such projection arrays and how to form them are described in WO 2020/097319 (Wolk et al.), incorporated herein by reference.

### Cavity Array Structure

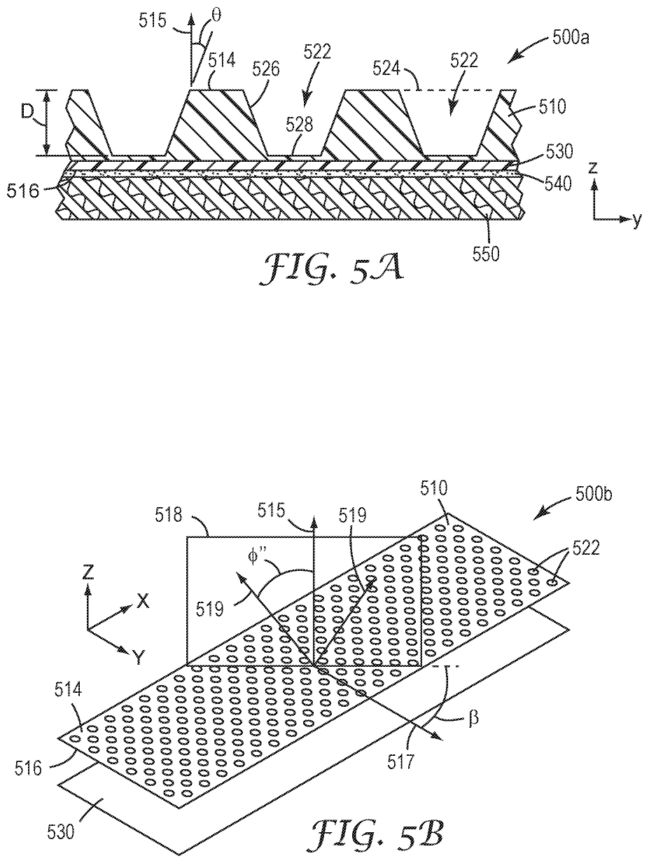

FIG. 5A shows an embodied microstructured film 500a having a cavity array structure, which can be coated to make a coated microstructured film 500a according to the present disclosure. A “cavity array” is an array of cavities having a density of discrete cavities of at least about 100/cm², and preferably at least about 10/mm². The cavities have a three-dimensional structure with dimensions, such as openings with, e.g., diameters in the range of between about 5-250 micrometers, and depths in the range between about 2-250 micrometers. The array can be any regular array such as a close-packed array or a rectangular array, or the cavities can be randomly distributed. More particularly, FIG. 5A is a schematic cross-sectional view of a microstructured film 500a having a plurality of cavities 522 extending between a first major surface 514 and a second major surface 516. The microstructured film 500a comprises a microstructured layer 510 with first 514 and second 516 major surfaces, in which the microstructures comprise a plurality of cavities 522 extending between the first 514 and second 516 major surfaces. Each cavity comprises a first opening 524, a second opening 528 and at least one side wall 526 extending between the first opening 524 and the second opening 528. Each of the side wall(s) 526 forms a side wall angle θ with a line 515 perpendicular to the first major surface 514 of the microstructured layer 510. Each of the cavities 522 further includes a depth “D” which is the perpendicular distance between first aperture 524 and second aperture 528. Optionally, the microstructured film 500a further includes any of an adhesive layer 540, a first substrate 530, or a second substrate layer 550.

When such a cavity array structure is used in a coated microstructured film, the first portion on which the coating (not shown) is disposed comprises the at least one side wall 526 and the second portion comprises at least one of the first major surface 514 or the second major surface 516 of the microstructured layer 510.

FIG. 5B is generalized schematic top perspective exploded view of a microstructured film 500b having a plurality of cavities 522 extending between two major surfaces. The microstructured film 500b includes a microstructured layer 510 with a first major surface 514 and an opposing second major surface 516. The first major surface 514 includes an array of discrete cavities 522. In one particular embodiment, each of the cavities 522 includes a cross-section parallel to the first major surface 514 that can be circular shaped, oval shaped, or polygon shaped. The cross-section optionally decreases in size in the direction from the first major surface 514 to the second major surface 516. This embodiment of a microstructured film 500b further includes a (e.g., flexible) substrate 530 coupled to the second major surface 516 of the microstructured layer 510. A set of coordinate axes is shown to illustrate that the cavities 522 can be optically isolated such that light is not substantially transmitted within the plane formed by the x- and y-axes. However, light can be substantially transmitted from the cavities 522 in a direction 515 that is predominantly oriented toward the z-axis (that is, in the perpendicular direction from the microstructured film 500b).

Further details regarding microstructured films having such cavity arrays and how to form them are described in U.S. Pat. No. 9,329,311 (Halverson et al.), incorporated herein by reference.

As mentioned above, the coating (e.g., layer) of the coated microstructured film is essentially free of any light absorptive material. This is in contrast to prior articles, e.g., light control films, which incorporate a light absorptive material into the article at the time of manufacture. Moreover, the microstructured film itself is typically essentially free of any light absorptive material. The lack of light absorptive material in the coating (and preferably also the film itself) of coated microstructured films of the present disclosure results in the coated microstructured film tending to exhibit a transmission of visible light of 75% or greater at a viewing angle of 0 degrees, in which the viewing angle is measured relative a line perpendicular (i.e., normal) to the first surface of the microstructured film. In some cases, the coated microstructured film exhibits a transmission of visible light of 75% or greater, 76%, 77%, 78%, 79%, 80%, 81%, 82%, 83%, 84%, 85%, 86% 87%, 88%, 89%, 90%, 91%, 92%, 93%, 94%, 95%, 96%, 97%, 98%, or even 99% or greater at a viewing angle of 0 degrees. Visible light transmission (% T) at a viewing angle of 0 degrees can be measured with a BYK (Geretsried, Germany) Haze-gard i instrument. Further, the coated microstructured film tends to exhibit a transmission of visible light of 75% or greater at a viewing angle of +45 degrees, as determined according to the test method of “Measuring the Luminance Profile from a Diffuse Light Source” described below. In some cases, the coated microstructured film exhibits a transmission of visible light of 76% or greater, 78%, 80%, 82%, 84%, 86%, 88%, 90%, 92%, 94%, 96%, 98%, or even 100% or greater at a viewing angle of +45 degrees. Having a visible light transmission of greater than 100% is possible due to reflections from microstructures that can redirect high angle light from the diffuse light source to the detector.

In a third aspect, a method of making a light control film is provided. The method comprises:
a) obtaining a microstructured film comprising a plurality of microstructures extending across a first surface of the microstructured film;
b) applying a coating comprising one or more polyelectrolytes to the microstructures across the first surface of the microstructured film, the coating having an average thickness T; and
c) removing at least a portion of the coating from a second portion of the microstructures to provide the coating disposed on a first portion of the microstructures, thereby forming a coated microstructured film; and
d) either i) infusing a light absorptive material into the coating of the coated microstructured film or ii) applying a layer of a pigment on the coating;
wherein the light control film exhibits a transmission of visible light of 75% or greater at a viewing angle of 0 degrees.

Referring back to FIG. 1A, the method of making a light control film comprises Step 1000 to a) obtain a microstructured film comprising a plurality of microstructures extending across a first surface of the microstructured film and Step 1100 to b) apply a coating comprising one or more polyelectrolytes to the microstructures across the first surface of the microstructured film, the coating having an average thickness T (i.e., wherein the coating is essentially free of any light absorptive material). Step 1200 is further included, to c) remove at least a portion of the coating from a second portion of the microstructures to provide the coating disposed on a first portion of the microstructures. A coated microstructured film is thereby formed.

The method further comprises Step d) 1300 to either i) infuse a light absorptive material into the coating of the coated microstructured film or ii) apply a layer of a pigment on the coating. The light control film exhibits a transmission of visible light of 75% or greater at a viewing angle of 0 degrees. Referring back to FIG. 1B, a coated microstructured film 100c is shown, having a coating 130 on a first portion 132 of the microstructures 110 but absent from the second portion 134 of the microstructures 110. Next, a light control film 100d is shown having a light absorptive material (e.g., dye or pigment) infused in or applied to the coatings 130 (of the coated microstructured film 100c) to provide a light absorptive coating 131 on the first portion of the microstructures 110, e.g., disposed on the side walls 103 and 105 of the ribs 112.

Instead of using light-absorbing pigments or dyes as the constituents of the coating on the microstructured film, non-light absorbing polyelectrolytes are used. The resulting coating is a thin, conformal, ionically cross-linked “hydrogel” comprising cationic and anionic polymers with latent functional groups. The basis for the customizability of such light control films is the layer-by-layer (LbL) coating of polyelectrolytes, which are capable of exchanging small counterions for other ions (e.g., dyes). Accordingly, the coatings may be infused with one or more water-soluble, ionic/charged dyes to impart desired absorption of electromagnetic radiation. Moreover, the LbL coatings are also capable of adsorbing monolayers of pigments on the surface. These LbL coatings can swell in water and latent functional groups can bind water-soluble, ionic dyes through ion exchange reactions. Optionally, when strong polyelectrolytes are used, the LbL coating comprises residual small counterions (e.g., sodium and/or chloride ions). The coating can be analyzed, such as by x-ray photoelectron spectroscopy (XPS) to probe the coating surface or in conjunction with argon cluster depth profiling to probe the bulk of the coating, to determine an amount of residual counterions in the coating, which is an indication of the extent to which the coating is capable of having ion exchange reactions with the dyes. When strong polyelectrolytes are used, and a halide salt is used as a screening agent, the surface of the coating may have at least 0.1, 0.2, 0.3, 0.4, 0.5, 0.6, 0.7, 0.8, 0.9, or 1.0 atomic wt. % of the halide salt anion (e.g., chloride) for a LbL coating terminated by the polycation, or at least 0.1, 0.2, 0.3, 0.4, 0.5, 0.6, 0.7, 0.8, 0.9, or 1.0 atomic wt. % of the halide salt cation (e.g., sodium) for a LbL coating terminated by the polyanion. Alternatively, when weak polyelectrolytes are used, the polyelectrolyte constituents of the coating may be partially protonated depending on the pH of the surrounding medium and the pKa of the polyelectrolytes.

The extent of swelling of the LbL coating and porosity of the coating can influence dye loading. Optionally, multiple dyes can be loaded in a coating simultaneously, but the dye combination must be judiciously selected to achieve the desired color. Certain dyes, based on molecular weight, number of charged groups, etc., will preferentially absorb and ion-exchange over others. In some cases, the light absorptive material preferably comprises at least one ionic dye.

The relevant dyes possess at least one ionizable/charged functional group and may be zwitterionic. Loading/efficiency of dye infusion into the polyelectrolyte coatings can be influenced by the LbL coating itself (e.g., charge of the outermost layer of the LbL coating, thickness of the LbL coating, pH used for coating deposition, ionic strength used for coating deposition), as well as conditions of the dye bath (e.g., dye concentration, soak time, pH, etc.). For LbL coatings comprising strong polyelectrolytes, dye loading is greatest when the net charge of the dye is opposite the charge of the polyelectrolyte on the coating surface. Without wishing to be bound by theory, it is believed that Donnan exclusion limits infusion of dyes when they possess the same charge as the outermost polyelectrolyte layer. For example, loading of an Acid Dye is significantly higher for coatings terminated by a polycationic polymer; for instance, at least 4 times greater, 5 times, 6 times, 7 times, 8 times, 9 times, or 10 times greater. Loading of an Acid Dye can be negligible to low for coatings terminated by a polyanionic polymer. Likewise, loading of a Basic Dye can be negligible to low for coatings terminated by a polycationic polymer.

Referring again to FIG. 1A, in any method of making a light control film, Step 1300 may include i) to infuse a light absorptive material into the coating of the coated microstructured film and further comprise applying a layer of a pigment on the coating after step d).

It was discovered that effective dye loading into the LbL coating could still take place following removal of some of the coating using reactive ion etching (RIE). RIE is carried out in an oxidative oxygen plasma, thus the RIE could potentially have rendered the surface of the LbL coatings anionic; however, anionic (acid) dye loading was discovered to still be possible and primarily selective to the first portion of the microstructure where the LbL coating remained following RIE.

Suitable cationic (e.g., basic) dyes include, for example and without limitation, Basic Blue 7, Basic Blue 9 (methylene blue), Basic Blue 26, Basic Violet 2 and Basic Violet 14, Basic Yellow 57, Basic Red 76, Basic Blue 16, Basic Blue 347 (Cationic Blue 347/Dystar), HC Blue No. 16, Basic Blue 99, Basic Brown 16, Basic Brown 17, Basic Yellow 57, Basic Yellow 87, Basic Orange 31, or Basic Red 51.

Suitable anionic (e.g., acid) dyes include, for example and without limitation, one or more compounds from the following group: Acid Yellow 1 (D&C Yellow 7, Citronine A, Ext. D&C Yellow No. 7, Japan Yellow 403, CI 10316, COLIPA No.B001), Acid Yellow 3 (COLIPANo.: C 54, D&C Yellow No. 10, Quinoline Yellow, E104, Food Yellow 13), Acid Yellow 9 (CI 13015), Acid Yellow 17 (CI 18965), Acid Yellow 23 (COLIPA n° C. 29, Sicovit Tartrazine 85 E 102 (BASF), Tartrazine, Food Yellow 4, Japan Yellow 4, FD&C Yellow No. 5), Acid Yellow 36 (CI 13065), Acid Yellow 121 (CI 18690), Acid Orange 6 (CI 14270), Acid Orange 7 (2-Naphthol orange, Orange II, CI15510, D&C Orange 4, COLIPA No.C015), Acid Orange 10 (CI16230; Orange G sodium salt), Acid Orange 11 (CI 45370), Acid Orange 15 (CI 50120), Acid Orange 20 (Cl 14600), Acid Orange 24 (BROWN 1; CI 20170; KATSU201);; ACID ORANGE 24; Japan Brown 201; D& C Brown No. 1), Acid Red 14 (C.1.14720), Acid Red 18 (E124, Red 18; Cl 16255), Acid Red 27 (E 123, Cl 16185, C-Red 46, Echtrot D, FD&C Red No. 2, Food Red 9, Naphthol Red S), Acid Red 33 (Red 33, Fuchsia Red, D&C Red 33, Cl 17200), Acid Red 35 (CI 18065), Acid Red 51 (CI 45430, Pyrosine B, tetraiodofluorescein, Eosin J, iodosine), Acid Red 52 (CI 45100, Food Red 106, Solar Rhodamine B, Acid Rhodamine B, Red No. 106 Pontacyl Brilliant pink), Acid Red 73 (CI27290), Acid Red 87 (Eosin, CI45380), Acid Red 92 (COLIPA n ° C.53, CI45410), Acid Red 95 (CI 45425, Erythtosine, Simacid erythrosine Y), Acid Red 184 (CI 15685), Acid Red 195, Natural Red 4 (carminic acid), Acid Violet 43 (Jarocol Violet 43, Ext. D&C Violet n ° 2, CI60730, COLIPA No.C063), Acid Violet 49 (CI 42640), Acid Violet 50 (CI50325), Acid Blue 1 (patent Blue, CI 42045), Acid Blue 3 (patent Blue V, CI42051), Acid Blue 7 (CI 42080), Acid Blue 104 (CI 42735), Acid Blue 9 (E 133, patent Blue AE, amido Blue AE, Erioglaucin A, CI 42090, CI Food Blue 2), Acid Blue 62 (CI 62045), Acid Blue 74 (E 132, CI 73015), Acid Blue 80 (CI 61585), Trypan blue, Acid Green 3 (CI 42085, Foodgreen1), Acid Green 5 (CI 42095), Acid Green 9 (CI 42100), Acid Green 22 (CI 42170), Acid Green 25 (CI 61570, Japan Green 201, D&C Green No. 5), Acid Green 50 (Brilliant Acid Green BS, CI 44090, Acid Brilliant Green BS, E 142), Acid Black 1 (Black No. 401, Naphthene Black 10B, Amido Black 10B, CI 20470, COLIPA No. B15), Acid Black 52 (CI 15711), Eriochrome Black T, Nigrosin (water soluble), Food Yellow 8 (CI 14270), Food Blue 5, D&C Yellow 8, D&C Green 5, D&C Orange 10, D&C Orange 11, D&C Red 21, D&C Red 27, D&C Red 33, D&C Violet 2, and/or D&C Brown 1.

Some of major classes of dyes/pigments include phthalocyanines, cyanine, transition metal dithioline, squarylium, croconium, quinones, anthraquinones, iminium, pyrylium, thiapyrilium, azulenium, azo, perylene and indoanilines. Many of these dyes and pigments can exhibit both visible and/or infrared lights absorption as well. Further, many different types of visible dyes and colorants may be used such as acid dyes, azoic coloring matters, coupling components, diazo components. Basic dyes include developers, direct dyes, disperse dyes, fluorescent brighteners, food dyes, ingram dyes, leather dyes, mordant dyes, natural dyes and pigments, oxidation bases, pigments, reactive dyes, reducing agents, solvent dyes, sulfur dyes, condense sulfur dyes, vat dyes. Some of the organic pigments may belong to one or more of monoazo, azo condensation, insoluble metal salts of acid dyes and disazo, naphthols, arylides, diarylides, pyrazolone, acetoarylides, naphthanilides, phthalocyanines, anthraquinone, perylene, flavanthrone, triphendioxazine, metal complexes, quinacridone, polypryrrolopyrrole etc.

Suitable pigments are available commercially as colloidally stable water dispersions from manufacturers such as Cabot, Clariant, Orient, Penn Color, Sun Color, DuPont, Dai Nippon and DeGussa. Particularly suitable pigments include those available from Cabot Corporation under the CAB-O-JETR name, for example 200 (black), 300 (black), 352K (black), 400 (black), 250C (cyan), 260M (magenta), and 270Y (yellow). Multiple pigments may be utilized to achieve a specific hue or shade or color in the final product. When multiple pigments are used, the materials are selected to ensure their compatibility and performance both with each other and with the optical product components. The light absorbing (e.g., pigment) particles are typically surface treated to impart ionizable functionality. Examples of suitable ionizable functionality for light absorbing (e.g., pigment) particles include sulfonate functionality, carboxylate functionality as well as phosphate or bisphosphonate functionality. In some embodiments, surface treated light absorbing (e.g., pigment) particles having ionizable functionality are commercially available, such as those listed above. When the light absorbing (e.g., pigment) particles are not pre-treated, the light absorbing (e.g., pigment) particles can be surface treated to impart ionizable functionality as known in the art. A pigment can be coated onto an LbL coating, for instance by immersion (e.g., dip coating) of the coated microstructured film into an aqueous suspension containing the pigment, or by spraying, spin coating, roll coating, inkjet printing, and the like. Preferably, the pigment should have a sufficiently positive or negative zeta potential such that it will adsorb onto the surface of an LbL coating with zeta potential having the opposite sign in the pigment suspension.

Referring again to FIG. 1B, in some cases, the microstructures 110 of a light control film 100d comprise a plurality of ribs 112 alternated with channels 114 extending across the first surface 102 of the microstructured film, and the method further comprises filling the channels 114 with an organic polymeric material 113. In some embodiments, the organic polymeric material is a polymerizable resin composition and the method further comprises (e.g., radiation) curing the polymerizable resin. Often, the same polymerizable resin used in the manufacture of the microstructured film is utilized for filling the channels. Alternatively, a different organic polymeric material (e.g., polymerizable resin composition) is used. When a different organic polymer material (e.g., polymerizable resin composition) is used, the composition is typically selected to be index matched to the ribs. By “index matched”, it is meant that the difference in refractive index between the filling material and ribs is typically less than 0.1 or 0.005. Alternatively, the channels may be filled with a different organic polymeric material (e.g., polymerizable resin composition) having a difference in refractive index of greater than 0.1. In yet another embodiment, the channels are not filled with an organic polymeric material (e.g., polymerized resin). In this embodiment, the channels typically comprise air, having a refractive index of 1.0.

When the channels are filled with a cured polymerizable resin, the light control film 100e may optionally include cover film 117 bonded to the microstructured film with adhesive. Suitable adhesives include any optically clear adhesive, such as a UV-curable acrylate adhesive, a transfer adhesive, and the like. In yet another embodiment, a topcoat may be included rather than a cover film.

Light control films may further comprise other coatings typically provided on the exposed surface. Various hardcoats, antiglare coatings, antireflective coatings, antistatic, and anti-soiling coatings are known in the art. See for example U.S. Pat. Nos. 7,267,850; 7,173,778, PCT Publication Nos. WO2006/102383, WO2006/025992, WO2006/025956 and U.S. Pat. No. 7,575,847.

When the channels are filled with air, the adhesive film and cover film are typically included. When the channels are filled with air, the relative transmission (e.g., brightness) at higher viewing angles can be lower, and thus the film can exhibit improved privacy or more intense color with angle

The resulting article 100e shown in FIG. 1B is a high aspect ratio louver film capable of angular- and, optionally, wavelength-selective light control.

The light control films described herein are particularly useful as a component of a display device as a so-called hybrid privacy filter. The hybrid privacy filter may be used in conjunction with a display surface, wherein light enters the hybrid privacy filter on the input side of the light control film and exits the hybrid privacy filter or film stack at a color shifting film (e.g., a multilayer film that imparts a color shifting effect such as described in U.S. Pat. No. 8,503,122. Suitable color shifting films are described in U.S. Pat. No. 6,531,230 to Weber et al). A great number of electronic devices with displays may be used in conjunction with the present invention including laptop monitors, external computer monitors, cell phone displays, televisions, smart phones, automotive center information displays, automotive driver information displays, automotive side mirror displays (also referred to as e-mirrors), consoles, or any other similar LCD, OLED, micro-LED, or mini-LED based display. An additional benefit to applying hybrid privacy filters to a display is for contrast enhancement.

In further embodiments, the light control film described herein can be useful as coverings for glass. For instance, the light control films may be laminated onto or within fenestrations. The fenestrations may be selected from a glass panel, a window, a door, a wall, and a skylight unit. These fenestrations may be located on the outside of a building or on the interior. They may also be car windows, train windows, airplane passenger windows, or the like. Advantages of incorporating these film stacks into fenestrations include reduced IR transmission (which may lead to increased energy savings), ambient light blocking, privacy, and decorative effects.

In further embodiments, the light control film described herein can be useful for branding on consumer products such as consumer electronics or apparel. For example, a company logo could appear at an oblique viewing angle.

In further embodiments, the light control film described herein can be used in a part of an optical communication system with a sensor, for instance a photoplesmography or other optical sensor applied to a watch. A light control film may be attached to a wearable wrist watch or any wearable device, e.g., attached to a surface of the optical sensor interface on the wearable device. The light absorptive material (e.g., dye and/or pigment) of the light control film may be any suitable material such that it is spectrally selective in at least a part of light (UV, VIS, NIR, SWIR) range from the light source, for example, an LED or laser source. Such light control films could also include a second light absorptive material in or on an exterior layer (e.g., a top coat or cover film) that is spectrally selective in at least a part of at least one of the mentioned light ranges from the LED. When the light control film is in use, noises sources such as unwanted light from the perspective of the sensor are absorbed through the second material regardless of the incidence angle of the light from light source, such as sunlight or the LED. The second material transmits a range of visible from the LED but the transmission of the light through the entire light control film varies as a function of the incidence angle of the light because the (first) light absorptive material may block or decrease the sunlight or ambient visible light from other light sources that are incident with relatively high incidence angle to (e.g., a wrist of the person wearing) the device so that the light control film may improve signal to noise ratio.

Referring again to FIG. 2B, when the coated microstructured film has been made into a light control film by infusing/coating a light absorptive material, the light control film includes alternating transmissive regions (i.e., ribs) 230 and absorptive regions (i.e., coating containing light absorptive material) 140, and an interface 150 between transmissive regions 230 and absorptive regions 140. Interface 150 forms a wall angle θ with line 160 that is perpendicular to light output surface 120. The transmission (e.g., brightness of visible light) can be increased when incident light undergoes total internal reflection (TIR) from the interface between the absorptive and transmissive regions. Whether a light ray will undergo TIR or not, can be determined from the incidence angle with the interface, and the difference in refractive index of the materials of the transmissive and absorptive regions.

Referring again to FIG. 2B, for a light control film having a louver microstructure, transmissive regions 230 between absorptive regions 140 have an interface angle θ_{I} defined by the geometry of alternating transmissive regions 230 and absorptive regions. The interface angle θ_{I} can be defined by the intersection of two lines. The first line extends from a first point, defined by the bottom surface and the side wall surface of a first absorptive region, and a second point defined by the top surface and side wall surface of the nearest second absorptive region. The second line extends from a first point defined, by the top surface and the side wall surface of the first absorptive region, and a second point, defined by the bottom surface and side wall surface of the second absorptive region. The polar cut-off viewing angle θP is equal to the sum of a polar cut-off viewing half angle θ1 and a polar cut-off viewing half angle θ2 each of which are measured from the normal to a light input surface 202. In typical embodiments, the polar cut-off viewing angle θP is symmetric, and polar cut-off viewing half angle θ1 is equal to polar viewing half angle θ2. Alternatively, the polar cut-off viewing angle θP can be asymmetric, and polar cut-off viewing half angle θ1 is not equal to polar cut-off viewing half angle θ2.

Luminance can be measured according to the test method of “Measuring the Luminance Profile from a Diffuse Light Source” described below. The luminance can be measured on the alternating transmissive and absorptive regions or the total light control film that may further comprise a cover film. Relative transmission (e.g., brightness of visible light) is defined as the percentage of luminance, at a specified viewing angle or range of viewing angles, between a reading with the light control film including the alternating transmissive and absorptive regions and optionally other layers and a reading without the light control film (i.e., the baseline). The viewing angle can range from −90 degrees to +90 degrees. A viewing angle of 0 degrees is orthogonal to light input surface 202; whereas viewing angles of −90 degrees and +90 degrees are parallel to light input surface 202. Unless specified otherwise, the relative transmission refers to the relative transmission of visible light having a 400-700 nm wavelength range as measured by the test method described in further detail in the examples.

The alternating transmissive (e.g., ribs) and absorptive (e.g., coating including light absorptive material) regions or the total light control film can exhibit increased relative transmission (e.g., brightness) at a viewing angle of 0 degrees. In some embodiments, the relative transmission (e.g., brightness) is at least 75, 80, 85, or 90%. The relative transmission (e.g., brightness) is typically less than 100%. In typical embodiments, the light control film has significantly lower transmission at other viewing angles. For example, in some embodiments, the relative transmission (e.g., brightness) at a viewing angle of −30 degrees, +30 degrees, or an average of −30 degrees and +30 degrees is less than 50, 45, 40, 35, 30, or 25%. In other embodiments, the relative transmission (e.g., brightness) at a viewing angle of 30 degrees, +30 degrees, or the average of −30 degrees and +30 degrees is less than 25, 20, 15, 10 or 5%. In some embodiments, the relative transmission (e.g., brightness) at a viewing angle of +/−35, +/−40, +/−45, +/−50, +/−55, +/−60, +/−65, +/−70, +/−75, or +/−80 degrees is less than 25, 20, 15, 10 or 5%, or less than 5%. In some embodiments, the average relative transmission (e.g., brightness) for viewing angles ranging from +35 to +80 degrees, −35 to −80 degrees, or the average of these ranges is less than 10, 9, 8, 7, 6, 5, 4, 3, or 2%.

Referring again to FIG. 3B, for a light control film having a linear prism microstructure, the coating 352 can be made to be an optically absorptive layer by incorporating one or more dyes/pigments. The optically absorptive layer may be used to block light (e.g., at a wavelength in the range of 400-1500 nm) incident on the sidewall 318 that would otherwise be redirected into an undesired direction. For example, light rays 391 and 392 are incident on the second major surface 314 along a substantially same direction, and light ray 391 is refracted by an optical facet into a desired direction while light ray 392 is blocked from being redirected by a sidewall into an undesired direction. Similarly, light rays 393 and 394 are incident on the first major surface 312 along a substantially same direction, and light ray 393 is refracted by an optical facet into a desired direction while light ray 394 is blocked from being redirected by a sidewall into an undesired direction.

Referring again to FIG. 5B, for a light control film having a cavity array microstructure, a viewing plane 518 is shown to be positioned at an azimuthal angle β from the y-z plane (defined by a perpendicular line 515 parallel to the z-axis and the line 517 parallel to the y-axis). The viewing plane 518 includes the perpendicular line 515 parallel to the z-axis, and extends perpendicular to the x-y plane. The viewing plane 518 further includes viewing cutoff lines 519 located at a viewing cutoff angle φ″ measured from the perpendicular line 515, such that for any angle greater than the viewing cutoff angle φ″, light (e.g., at a wavelength in the range of 400-1500 nm) is not substantially transmitted through microstructured film 500b. The magnitude of the viewing cutoff angle φ″ can vary, depending on the azimuthal angle β and the geometry of the cavities 522. In some embodiments, the viewing cutoff angle φ″ can vary from about 10 degrees to about 70 degrees. In some embodiments, the viewing cutoff angle φ″ can remain constant as the azimuthal angle varies from 0 to 360 degrees (for example, when the cavities include a circular cross-section). In some embodiments, the viewing cutoff angle φ″ can vary as the azimuthal angle varies from 0 to 360 degrees.

As mentioned above, for certain applications of light control films there may be very specific wavelength-selectivity desired, such as for small-volume applications. Large amounts of customizable coated microstructured films according to the present disclosure can be economically made and then sections may be post-processed and customized for the smaller volume applications. Accordingly, the method optionally further comprises, prior to step d): e) preparing a roll of the coated microstructured film; and f) cutting at least one piece of the coated microstructured film from the roll, wherein step d) is performed on at least one of the pieces of the coated microstructured film. Referring again to FIG. 1A, in some cases the method further comprises Step 1400 to e) prepare a roll of the coated microstructured film and Step 1500 to f) cut at least one piece of the coated microstructured film from the roll, in which Step 1300 (i.e., to d) either i) infuse a light absorptive material into the coating of the coated microstructured film or ii) apply a layer of a pigment on the coating) is performed on at least one of the pieces of the coated microstructured film.

This method enables large-scale preparation of a customizable microstructured film to which can be added or incorporated light-absorbing materials (e.g., by post-infusion or coating with one or more dyes and/or pigments) to achieve a desired wavelength-selectivity on a small volume product scale.

### Exemplary Embodiments

In a first embodiment, the present disclosure provides a coated microstructured film. The coated microstructured film comprises a) a plurality of microstructures extending across a first surface of the microstructured film; and b) a coating disposed on a first portion of at least some of the microstructures. The coating comprises one or more polyelectrolytes and has an average thickness T. A second portion of the microstructures either lacks the coating or comprises the coating disposed thereon having an average thickness of no more than 50% of T. The coating is essentially free of any light absorptive material.

In a second embodiment, the present disclosure provides a coated microstructured film according to the first embodiment, wherein the microstructures comprise a plurality of ribs alternated with channels extending across the first surface of the microstructured film and wherein each of the ribs comprises side walls and a top surface and each of the channels comprises a bottom surface. The first portion on which the coating is disposed comprises the side walls of the ribs and the second portion comprises the top surfaces of the ribs and the bottom surfaces of the channels.

In a third embodiment, the present disclosure provides a coated microstructured film according to the second embodiment, wherein each rib has a width W and a height H and wherein H/W≥1.5.

In a fourth embodiment, the present disclosure provides a coated microstructured film according to the second embodiment or the third embodiment, wherein the ribs have a width parallel to the first surface and a height orthogonal to the first surface.

In a fifth embodiment, the present disclosure provides a coated microstructured film according to any of the second through fourth embodiments, wherein the side walls of the ribs have a wall angle less than 5, 4, 3, 2, 1, or 0.1 degrees.

In a sixth embodiment, the present disclosure provides a coated microstructured film according to the second embodiment or the third embodiment, wherein the side walls comprise first and second side walls, wherein the first side wall has a wall angle with a line that is perpendicular to the first surface of the microstructured film from 0 degrees to +10 degrees or from 0 degrees to −10 degrees relative to the bottom surface.

In a seventh embodiment, the present disclosure provides a coated microstructured film according to any of the second through sixth embodiments, wherein the ribs have a height ranging from 50 to 200 micrometers.

In an eighth embodiment, the present disclosure provides a coated microstructured film according to any of the second through seventh embodiments, wherein the channels have an average pitch of 10 to 200 micrometers.

In a ninth embodiment, the present disclosure provides a coated microstructured film according to the first embodiment, wherein the microstructures comprise a facet and a side wall meeting the facet at a ridge of the microstructure and wherein the facet and the side wall define an oblique angle therebetween; and wherein the first portion on which the coating is disposed comprises the side wall and the second portion comprises the facet.

In a tenth embodiment, the present disclosure provides a coated microstructured film according to the ninth embodiment, wherein each of the microstructures is a) a linear prism having a substantially same angle between the optical facet and the side wall or b) a linear Fresnel element.

In an eleventh embodiment, the present disclosure provides a coated microstructured film according to the first embodiment, wherein the microstructures comprise a two-dimensional (x- & y-axes) array of projections arranged across the first surface of the microstructured film: wherein each of the projections comprises a base, a top, and one or more sides connecting the top to the base; and wherein the first portion on which the coating is disposed comprises the sides and the second portion comprises the top.

In a twelfth embodiment, the present disclosure provides a coated microstructured film according to the eleventh embodiment, wherein each of the projections is a spaced-apart post and the second portion further comprises a surface of the microstructured film between the spaced-apart posts.

In a thirteenth embodiment, the present disclosure provides a coated microstructured film according to the first embodiment, wherein the microstructured film comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening; and wherein the first portion on which the coating is disposed comprises the at least one side wall and the second portion comprises at least one of the first major surface or the second major surface of the microstructured layer.

In a fourteenth embodiment, the present disclosure provides a coated microstructured film according to the thirteenth embodiment, wherein each of the at least one side walls forms a side wall angle θ with a line perpendicular to the first major surface of the microstructured layer.

In a fifteenth embodiment, the present disclosure provides a coated microstructured film according to any of the first through fourteenth embodiments, wherein the average thickness T is 0.1 nanometers to 5 micrometers.

In a sixteenth embodiment, the present disclosure provides a coated microstructured film according to any of the first through fifteenth embodiments, wherein the coated microstructured film exhibits a transmission of visible light of 75% or greater at a viewing angle of 0 degrees.

In a seventeenth embodiment, the present disclosure provides a coated microstructured film according to any of the first through sixteenth embodiments, wherein the coated microstructured film exhibits a transmission of visible light or 75% or greater at a viewing angle of +45 degrees.

In an eighteenth embodiment, the present disclosure provides a coated microstructured film according to any of the first through seventeenth embodiments, wherein the microstructured film is essentially free of any light absorptive material.

In a nineteenth embodiment, the present disclosure provides a coated microstructured film according to any of the first through eighteenth embodiments, wherein the polyelectrolytes comprise polymers containing quaternary ammonium groups or sulfonic acid groups.

In a twentieth embodiment, the present disclosure provides a coated microstructured film according to any of the first through nineteenth embodiments, wherein the coating surface comprises at least 0.1 atomic weight % of a halide.

In a twenty-first embodiment, the present disclosure provides a coated microstructured film according to any of the first through twentieth embodiments, wherein the polyelectrolytes comprise polymers containing primary, secondary, or tertiary amines, or carboxylic acids, or phosphonic acids.

In a twenty-second embodiment, the present disclosure provides a coated microstructured film according to any of the first through twenty-first embodiments, wherein a surface of the coating exhibits a positive zeta potential at a pH in the range of 1-14.

In a twenty-third embodiment, the present disclosure provides a method of making a coated microstructured film according to any of the first through twenty-second embodiments. The method comprises a) obtaining a microstructured film comprising a plurality of microstructures extending across a first surface of the microstructured film and b) applying a coating comprising one or more polyelectrolytes to at least some of the microstructures across the first surface of the microstructured film. The coating has an average thickness T and is essentially free of any light absorptive material. The method further comprises c) removing at least a portion of the coating from a second portion of the microstructures to provide the coating disposed on a first portion of the microstructures.

In a twenty-fourth embodiment, the present disclosure provides a method of making a light control film. The method comprises a) obtaining a microstructured film comprising a plurality of microstructures extending across a first surface of the microstructured film: b) applying a coating comprising one or more polyelectrolytes to at least some of the microstructures across the first surface of the microstructured film, the coating having an average thickness T; and c) removing at least a portion of the coating from a second portion of the microstructures to provide the coating disposed on a first portion of the microstructures, thereby forming a coated microstructured film. The method further comprises d) either i) infusing a light absorptive material into the coating of the coated microstructured film or ii) applying a layer of a pigment on the coating. The light control film exhibits a transmission of visible light of 75% or greater at a viewing angle of 0 degrees.

In a twenty-fifth embodiment, the present disclosure provides a method according to the twenty-fourth embodiment, wherein the microstructures comprise a plurality of ribs alternated with channels extending across the first surface of the microstructured film, and wherein the method further comprises filling the channels with an organic polymeric material.

In a twenty-sixth embodiment, the present disclosure provides a method according to the twenty-fourth embodiment or the twenty-fifth embodiment, wherein the light absorptive material comprises at least one ionic dye.

In a twenty-seventh embodiment, the present disclosure provides a method according to any of the twenty-fourth through twenty-sixth embodiments, wherein step d) comprises i) and further comprises applying a layer of a pigment on the coating after step d).

In a twenty-eighth embodiment, the present disclosure provides a method according to any of the twenty-fourth through twenty-seventh embodiments, further comprising, prior to step d): e) preparing a roll of the coated microstructured film; and f) cutting at least one piece of the coated microstructured film from the roll. Step d) is performed on at least one of the pieces of the coated microstructured film.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| P6010 | Aliphatic urethane diacrylate. Viscosity 5900 | BASF |
| | mPa · s at 60° C. Tensile Strength 2060 psi. | (Ludwigshafen, |
| | Tg = −7° C., obtained under the trade designation | Germany) |
| | “PHOTOMER 6010” | |
| SR602 | Ethoxylated (10) bisphenol A diacrylate | Sartomer (Exton, PA) |
| SR601 | Ethoxylated (4) bisphenol A diacrylate | Sartomer |
| TMPTA | Trimethylolpropane triacrylate | Cytec Industries |
| | | (Woodland Park, NJ) |
| PEA | Phenoxyethyl acrylate, obtained under the trade | Eternal Chemical |
| | designation “ETERMER 2010” | Co., Ltd. (Kaohsiung, |
| | | Taiwan) |
| D1173 | 2-Hydroxy-2-methylpropiophenone | BASF |
| | photoinitiator, obtained under the trade | |
| | designation “DAROCUR 1173” | |
| TPO | Diphenyl(2,4,6-trimethylbenzoyl)phosphine | BASF |
| | oxide photoinitiator | |
| I1035 | Anti-oxidant obtained under the trade | BASF |
| | designation “IRGANOX 1035” | |
| PDAC | Polydiallyldimethylammonium chloride, 45% | BASF |
| | solids in water, obtained under the trade | |
| | designation “DEHYQUART CC6” | |
| PSS | Polystyrene sulfonate, sodium salt, 30% in water | Sigma Aldrich Co. |
| | (“Typical Mw = 70,000 g/mol”) | (St. Louis, MO) |
| NaCl | Sodium chloride, obtained at a concentration of | Univar Solutions |
| | 25% solids in water | (Downers Grove, IL) |
| O₂ | Oxygen (Ultra High Purity compressed gas) | Oxygen Service |
| | | Company (St. Paul, |
| | | MN) |
| Acid Blue 25 | Acid Blue 25, dye content 45% | Sigma Aldrich Co. |
| Lissamine Green B | Lissamine Green B, dye content 60% | Sigma Aldrich Co. |
| Acid Orange 12 | Acid Orange 12 | Spectrum Chemical |
| | | Mfg. Corp. (New |
| | | Brunswick, NJ) |
| Acid Fuchsin | Acid Fuchsin, sodium salt, dye content 70% | Sigma Aldrich Co. |
| COJ200 | Anionic, surface-modified carbon black (20% | Cabot Corp. (Boston, |
| | solids in water), obtained under the trade | MA) |
| | designation “CAB-O-JET 200” | |

### Test Methods

### Test Method 1: Measuring the Visible Light Transmission and Haze of a Coated Film

Visible light transmission (% T) and haze (% H) were measured with a BYK (Geretsried, Germany) Haze-gard i instrument. Samples were measured with the structured side of the microstructured film facing the light source.

### Test Method 2: Measuring the Thickness of a Coating on Glass

Coating thickness on glass was measured with a Dektak XT stylus profilometer (Bruker Nano Inc., Tucson, AZ) with a 1 mg tip force, after scoring the coating on glass with a razor blade. Coatings were deposited on a glass “witness”, which corresponded to a 3 inch (7.6 centimeter (cm)) wide section adjacent the 9 inches (23 cm) wide film adhered to a 12 inch×12 inch (30 cm×30 cm) glass plate, as described in the “Method for Making Layer-by-Layer Assembled Coatings”.

### Test Method 3: Measuring the Thickness of a Coating on a Silicon Wafer

Coating thickness on a silicon wafer was determined with a J.A. Woollam M2000VI spectroscopic ellipsometer (J.A. Woollam, Lincoln, NE). Coatings were deposited on a Si wafer “witness” adhered with tape to a 12 inch×12 inch (30 cm×30 cm) glass plate adjacent to the 9 inch×12 inch film (23 cm×30 cm) as described in the “Method for Making Layer-by-Layer Assembled Coatings”. Measurements were collected in reflection at angles of 55°, 60°, 65°, 70°, and 75° at a wavelength range of 370-1700 nanometers (nm). The resulting data were analyzed in WVASE32 software available from J.A. Woollam. Standard reference materials available in WVASE32 for the silicon and native oxide were used. The deposited coating was modeled with Cauchy dispersion, fixing the Cauchy refractive index parameters to the following values: An=1.45, Bn=0.01, Cn=0.

### Test Method 4: Measuring the Luminance Profile from a Diffuse Light Source

A sample of film was placed on a Lambertian light source. When the light transmissive regions are tapered, the film is positioned such that the widest portion of the tapered regions are closer to the light source. An Eldim L80 conoscope (Eldim S.A., Heroville-Saint-Clair, France) was used to detect light output in a hemispheric fashion at all polar and azimuthal angles simultaneously. After detection, a cross section of transmission (e.g., brightness) readings were taken in a direction orthogonal to the direction of the louvers (denoted as a 0° orientation angle), unless indicated otherwise. Relative transmission (i.e., brightness of visible light) is defined as the percentage of on-axis luminance, at a certain viewing angle, between a reading with film and a reading without the film.

The Lambertian light source consisted of diffuse transmission from a light box having the baseline luminance profile depicted in FIG. 6 of WO 2019/118685 A1 (Schmidt et al.). The light box was a six-sided hollow cube measuring approximately 12.5 cm×12.5 cm c 11.5 cm (L×W×H) made from diffuse polytetrafluoroethylene (PTFE) plates of approximately 6 millimeters (mm) thickness. One face of the box was chosen as the sample surface. The hollow light box had a diffuse reflectance of approximately 0.83 measured at the sample surface (e.g., approximately 83%, averaged over the 400-700 nm wavelength range). During testing, the box was illuminated from within through an approximately 1 cm circular hole in the bottom of the box (opposite the sample surface, with the light directed toward the sample surface from inside). The illumination was provided using a stabilized broadband incandescent light source attached to a fiber-optic bundle used to direct the light (Fostec DCR-II with a 1 cm diameter fiber bundle extension from Schott-Fostec LLC, Marlborough, MA and Auburn, NY).

### Test Method 5: Measuring Spectral Light Absorbance of a Coating on Glass

Absorbance of light from a wavelength of 350 nm to 800 nm (in increments of 5 nm) was measured using a Perkin Elmer (Waltham, MA) Lambda 1050 UV/Vis/NIR spectrophotometer with an integrating sphere. Samples were secured at the entrance to the integrating sphere and measured in transmission mode. The absorbance spectra of the coatings were determined by subtracting the absorbance spectrum of bare, uncoated glass from the absorbance spectrum of glass with a coating.

### Test Method 6: X-Ray Photoelectron Spectroscopy (XPS)

XPS was carried out with a Thermo Scientific (Waltham, Massachusetts) Nexsa™ instrument with the following conditions. Analysis area size was approximately 400 microns. Photoelectron take-off angle was 90°+30° solid angle of acceptance. The X-ray source was a monochromatic Al Kα (1486.6 eV) 72 W source. Analysis chamber pressure was less than 5×10⁻⁷ mbar (0.05 Pascals). Charge neutralization occurred with low energy electrons and Art flood sources. Charge correction was 284.8 eV for C—C/H.

### EXAMPLES

### Preparatory Example 1 (PE-1): Preparation of Microstructured Film

A diamond (29.0 micrometers (μm) tip width, 3° included angle, 87 μm deep) was used to cut a tool having a plurality of parallel linear grooves. The grooves were spaced apart by a pitch of 62.6 micrometers.

Resin A was prepared by mixing the materials in Table 2 below.

TABLE 2
Composition of Resin A used to make microstructured film

| Material | Parts by Weight |
|---|---|
| P6010 | 60 |
| SR602 | 20 |
| SR601 | 4.0 |
| TMPTA | 8.0 |
| PEA | 8.0 |
| D1173 | 0.35 |
| TPO | 0.10 |
| I1035 | 0.20 |

A “cast-and-cure” microreplication process was carried out with Resin A and the tool described above. The line conditions were: resin temperature 150° F. (65.6° C.), die temperature 150° F. (65.6° C.), coater IR 120° F. (48.9° C.) edges/130° F. (54.4° C.) center, tool temperature 100° F. (37.8° C.), and line speed 70 feet per minute (fpm) (0.36 meters per second (m/s)) Fusion D lamps, with peak wavelength at 385 nm, were used for curing and operated at 100% power. The resulting microstructured film comprised a plurality of protrusions (e.g., light transmissive regions) separated by channels as illustrated in FIG. 2A (described in detail above). The base layer was PET film (3M Company, St. Paul, MN), having a thickness of 2.93 mils (74.4 micrometers). The side of the PET film that contacts the resin was primed with a thermoset acrylic polymer (RHOPLEX 3208 available from Dow Chemical, Midland, MI). The land layer of the cured resin had a thickness of 8 micrometers. The protrusions of the microstructured film are a negative replication of the grooves of the tool. The protrusions have a wall angle of 1.5 degrees resulting in the protrusions being slightly tapered (wider at the light input surface and narrower at the light output surface). The channels of the microstructured film are a negative replication of the uncut portions of the tool between the grooves.

### Preparatory Example 2 (PE-2): Preparation of Layer-by-Layer (LBL) Coating Solutions

PDAC (1 molar (M) NaCl) coating solution was prepared by adding 481 grams (g) of NaCl (25%), 1584 g of deionized (DI) water, and 9.2 g of DEHYQUART CC6 to a plastic jug and shaking vigorously by hand. PSS (1 M NaCl) coating solution was prepared by adding 481 g of NaCl (25%), 1579 g of DI water, and 13.8 g of polystyrene sulfonate, sodium salt, 30% in water to a plastic jug and shaking vigorously by hand.

### Method for Making Layer-by-Layer Assembled Coatings

Layer-by-layer (LbL) assembled coatings were made using an apparatus purchased from Svaya Nanotechnologies, Inc. (Sunnyvale, CA) and modeled after the system described in U.S. Pat. No. 8,234,998 (Krogman et al.) as well as Krogman et al. Automated Process for Improved Uniformity and Versatility of Layer-by-Layer Deposition, Langmuir 2007, 23, 3137-3141. The apparatus comprises pressure vessels loaded with the coating solutions. Spray nozzles with a flat spray pattern (from Spraying Systems, Inc., Wheaton, IL) were mounted to spray the coating solutions and rinse water at specified times, controlled by solenoid valves. The pressure vessels (Alloy Products Corp., Waukesha, WI) containing the coating solutions were pressurized with nitrogen to 30 pounds per square inch (psi) (0.21 MPa), while the pressure vessel containing DI water was pressurized with air to 30 psi (0.21 MPa). Flow rates from the coating solution nozzles were each 10 gallons per hour (38 liters/hour), while flow rate from the DI water rinse nozzles were 40 gallons per hour (150 liters/hour). The substrate to be coated (9 inch×12 inch) (23 cm×30 cm) was adhered at the edges with epoxy (Scotch-Weld epoxy adhesive, DP100 Clear, 3M Company, St. Paul, MN) to a glass plate (12 inch×12 inch×⅛ inch thick) (30 cm×30 cm×0.3 cm) (Brin Northwestern Glass Co., Minneapolis, MN), which was mounted on a vertical translation stage and held in place with a vacuum chuck. In a typical coating sequence, the polycation (e.g., PDAC) solution was sprayed onto the substrate while the stage moved vertically downward at 76 millimeter/second (mm/sec). Next, after a dwell time of 12 sec, the DI water was sprayed onto the substrate while the stage moved vertically upward at 102 mm/sec. The substrate was then dried with an airknife at a speed of 3 mm/sec. Next, the polyanion (e.g., PSS) solution was sprayed onto the substrate while the stage moved vertically downward at 76 mm/sec. Another dwell period of 12 sec was allowed to elapse. The DI water was sprayed onto the substrate while the stage moved vertically upward at 102 mm/sec. Finally, the substrate was then dried with an airknife at a speed of 3 mm/sec. The above sequence was repeated to deposit a number of “bi-layers” denoted as (Polycation/Polyanion) n where n is the number of bi-layers. For deposition of a half bilayer (e.g., to only deposit a polycation or to cap the coating with the polycation), one last layer of polycation is deposited followed by rinse and dry as described above. The coated substrate (e.g., polymer film) was stripped off of the glass prior to subsequent processing. The coating on the glass was retained for thickness and light transmission measurements.

### Method for Reactive Ion Etching

Reactive ion etching was performed in a home-built parallel plate capacitively coupled plasma reactor. The chamber has a central cylindrical powered electrode with a surface area of 18.3 feet² (1.70 meters²). After placing the micro-structured film on the powered electrode, the reactor chamber was pumped down to a base pressure of 9.1 millitorr (mTorr) (1.2 kilopascals (kPa)) and O₂ (oxygen) gas was flowed into the chamber at a rate of 1000 standard cubic centimeters per minute (SCCM). Treatment was carried out using a plasma enhanced chemical vapor deposition (CVD) CVD method by coupling radio frequency (RF) power into the reactor at a frequency of 13.56 megahertz (MHz) and an applied power of 8000 Watts. Treatment time was controlled by moving the microstructured film through the reaction zone. Following the treatment, the RF power and the gas supply were stopped, and the chamber was returned to atmospheric pressure. Additional information regarding materials and processes for applying cylindrical reactive ion etching (RIE) and further details around the reactor used can be found in U.S. Pat. No. 8,460,568B2 (David et al.).

### Method for Back-Filling Channels of Microstructured Film

Resin A was heated to 150° F. (65.6° C.) in an oven. A microstructured film sample was taped to an aluminum plate, and then placed on a hot plate heated to 150° F. (65.6° C.). Resin A was pipetted between the microstructured film surface and a piece of primed, 3 mil-thick PET film placed on top; this construction was then sent through a GBC Catena 35 hot roll laminator heated to 150° F. with a speed of 5 feet/minute (2.54 cm/sec). The construction was then sent through a Heracus (Hanau, Germany) belt conveyer UV processor (Model #DRS (6)) with an ‘H’ bulb at 500 Watt power three times at a conveyer speed of 50 feet/minute (25.4 cm/sec). After curing, the PET top film was either left in place or stripped off.

### Examples 1-5: Microstructured Film with Linear Ribs, 18.5 Bilayers PDAC/PSS, Un-Dyed, Plus Infusion of Four Different Dyes

Sheets of microstructured film made in PE-1 were cut to a size of 9 inch×12 inch (23 cm×30 cm) and corona treated by hand on the structured side using a BD-20AC Laboratory Corona Treater (Electro-Technic Products, Chicago, IL) to facilitate wetting. PDAC (1 M NaCl) and PSS (1 M NaCl) coating solutions were made as described in PE-2. The microstructured film was coated with (PDAC/PSS) 18.5 using the “Method for Making Spray Layer-by-Layer Assembled Coatings on Microstructured Film”. The thickness of the (PDAC/PSS) 18.5 coating on the glass plate was measured to be 174±6 nm, using Test Method #2. XPS measurement (Test Method #6) found the coating surface to comprise 1.5 atomic wt. % chlorine, the counterion for the polycation (i.e., PDAC), which was the terminal layer in the coating. Next, the films were subjected to RIE using the “Method for Reactive Ion Etching” described above, for a duration of 45 seconds. One section of film was not subjected to further processing (EX-1). Other sections of film were immersed in separate 0.5% solids solutions of a dye (dissolved in DI water) for 2 minutes (min), rinsed with DI water, and dried with compressed air. The identities of the dyes were Acid Blue 25 (EX-2), Lissamine Green B (EX-3), Acid Orange 12 (EX-4) and Acid Fuchsin (EX-5). The EX-1 to EX-5 films appeared clear/colorless when viewed on-axis (perpendicular to the plane of the film). The EX-1 film appeared clear/colorless when the side walls were viewed at an off-axis, oblique angle (e.g., 45 degrees to the plane of the film) at a film orientation of 0 degrees (e.g., parallel to the plane of the film). The EX-2 to EX-5 films appeared strongly colored when viewed at an off-axis, oblique angle (e.g., 45 degrees to the plane of the film) at a film orientation of 0 degrees. Finally, sections of each EX-2 to EX-5 film were backfilled with Resin A as described in the “Method for Back-Filling Channels of the Microstructured Film”. The EX-2 to EX-5 films retained the colorless appearance on-axis and colored appearance off-axis. On-axis visible light transmission and haze (Test Method #1) are shown in Table 3 below. Relative angular light transmission from a diffuse light source (Test Method #4) is shown in Table 4 below.

To characterize the dye-loaded coatings on a planar substrate, sections of glass adjacent to the layer-by-layer coated microstructured film were used. The glass likewise had the (PDAC/PSS) 18.5 coating thereon. Approximately 1 inch (2.54 cm)×3 inch (7.62 cm) sections of glass were cut out with a silicon carbide cutting wheel, immersed in the 0.5% solids dye solutions mentioned above, rinsed with DI water, and dried with compressed air. The samples were characterized using the method of “Measuring Spectral Light Absorbance of a Coating on Glass” (Test Method #5). Peak wavelength and absorbance are shown in Table 5 below.

TABLE 3
Visible light transmission and haze for EX-1, EX-5, CE-1, and PE-1.

| | | | LbL | | | | | | % T | % H | | |
|---|---|---|---|---|---|---|---|---|---|---|---|---|
| | % T | % H | Coating | % T | % H | RIE | % T | % H | after | after | % T | % H |
| | before | before | Thickness, | after | after | Time, | after | after | dye | dye | after | after |
| Example | LbL | LbL | nm | LbL | LbL | sec | RIE | RIE | soak | soak | backfill | backfill |
| EX-1 | 92.0 | 15.8 | 174 | 92.4 | 19.4 | 45 | 93.2 | 19.2 | N/A | N/A | N/A | N/A |
| EX-5 | 92.0 | 15.8 | 174 | 92.4 | 19.4 | 45 | 93.2 | 19.2 | 89.5 | 15.4 | 87.1 | 10.4 |
| CE-1 | 92.0 | 15.8 | 174 | 92.4 | 19.4 | 0 | N/A | N/A | 64.5 | 13.2 | Did not | Did not |
| | | | | | | | | | | | measure | measure |
| Uncoated | 92.0 | 15.8 | N/A | N/A | N/A | N/A | N/A | N/A | N/A | N/A | 91.7 | 5.1 |
| channel | | | | | | | | | | | | |
| film | | | | | | | | | | | | |
| (PE-1) | | | | | | | | | | | | |

TABLE 4
Relative angular light transmission from a diffuse light source for EX-1, EX-5, CE-1, and PE-1.

| | Rel. % | Rel. % | Rel. % | Rel. % | Rel. % | Rel. % | Rel. % | Rel. % | Rel. % |
|---|---|---|---|---|---|---|---|---|---|
| | T at 0 | T at +30 | T at +45 | T at +60 | T at +75 | T at −30 | T at −45 | T at −60 | T at −75 |
| Example | degrees | degrees | degrees | degrees | degrees | degrees | degrees | degrees | degrees |
| EX-1 | 113% | 105% | 87.3% | 85.0% | 91.2% | 104% | 87.0% | 83.3% | 92.1% |
| EX-5 (before | 90.2% | 40.7% | 31.2% | 20.2% | 9.5% | 39.5% | 31.0% | 20.0% | 9.8% |
| backfill) | | | | | | | | | |
| EX- 5 (after | 93.2% | 56.7% | 87.3% | 39.6% | 29.1% | 55.8% | 47.3% | 39.1% | 28.5% |
| backfill) | | | | | | | | | |
| CE-1 | 70.5% | 33.4% | 24.0% | 20.7% | 20.3% | 33.2% | 23.5% | 18.5% | 18.7% |
| PE-1 | 114% | 108% | 84.9% | 82.2% | 94.2% | 112% | 88.4% | 81.7% | 96.3% |

Note: It is possible to have >100% relative light transmission with a channel film since reflections from the channel sidewalls can re-direct high angle light from the diffuse light source to the detector.

TABLE 5
Peak wavelength and peak absorbance for glass
witness samples corresponding to EX-1 to EX-5

| | Peak | Peak |
|---|---|---|
| | wavelength, | absorbance, |
| Example | nm | a.u. |
| EX-1 (glass witness) | N/A | N/A |
| EX-2 (glass witness) | 600 | 0.22 |
| EX-3 (glass witness) | 645 | 0.63 |
| EX-4 (glass witness) | 485 | 0.22 |
| EX-5 (glass witness) | 565 | 0.28 |

### Examples 6-7: Microstructured Film with Linear Ribs, 1 Layer of PDAC, No Further Processing & Pigment Adsorption

A sheet of microstructured film made in PE-1 was cut to a size of 9 inch×12 inch (23 cm×30 cm) and corona treated by hand on the structured side using a BD-20AC Laboratory Corona Treater (Electro-Technic Products, Chicago, IL) to facilitate wetting. PDAC (1 M NaCl) coating solution was made as described in PE-2. The microstructured film and Si witness wafer were coated with one layer of PDAC using the “Method for Making Spray Layer-by-Layer Assembled Coatings on Microstructured Film”. The thickness of the coating on the Si witness wafer was determined to be 0.66 nm, using Test Method #3. Next, the microstructured film was subjected to RIE using the “Method for Reactive Ion Etching” described above, for a duration of 5 seconds. One section of film was not subjected to further processing (EX-6). Another section of film was immersed in a suspension of 0.5% solids CAB-O-JET 200 (with 50 millimolar (mM) NaCl) for 1 min, rinsed with DI water, and dried with compressed air. The EX-6 and EX-7 films appeared clear/colorless when viewed on-axis (perpendicular to the plane of the film). The EX-6 film appeared clear/colorless when viewed at an off-axis, oblique angle (e.g., 45 degrees to the plane of the film) at a film orientation of 0 degrees. The EX-7 film appeared slightly darkened when viewed at an off-axis, oblique angle (e.g., 45 degrees to the plane of the film) at a film orientation of 0 degrees. On-axis visible light transmission and haze are shown in Table 6 below. Relative angular light transmission from a diffuse light source is shown in Table 7 below.

TABLE 6
Visible light transmission and haze for EX-6 and EX-7

| | | | LbL | | | | | | % T | % H |
|---|---|---|---|---|---|---|---|---|---|---|
| | % T | % H | Coating | % T | % H | RIE | % T | % H | after | after |
| | before | before | Thickness | after | after | Time | after | after | pigment | pigment |
| Example | LbL | LbL | (nm) | LbL | LbL | (s) | RIE | RIE | soak | soak |
| EX-6 | 94.4 | 10.9 | 0.66 | 94.4 | 10.9 | 5 | 95.3 | 12.9 | N/A | N/A |
| EX-7 | 94.4 | 10.9 | 0.66 | 94.4 | 10.9 | 5 | 95.3 | 12.9 | 92.5 | 10.2 |
| CE-2 | 94.4 | 10.9 | 0.66 | 94.4 | 10.9 | 0 | N/A | N/A | 68.9 | 10.0 |

TABLE 7
Relative angular light transmission from a diffuse light source for EX-6 and EX-7*

| | % T at 0 | % T at +30 | % T at +45 | % T at +60 | % T at +75 | % T at −30 | % T at −45 | % T at −60 | % T at −75 |
|---|---|---|---|---|---|---|---|---|---|
| Example | degrees | degrees | degrees | degrees | degrees | degrees | degrees | degrees | degrees |
| EX-6 | 115% | 109% | 102% | 76.5% | 37.7% | 106% | 105% | 70.7% | 37.5% |
| EX-7 | 103% | 85.4% | 71.0% | 44.8% | 16.1% | 81.3% | 70.8% | 39.4% | 16.7% |
| CE-2 | 72.5% | 41.1% | 22.9% | 14.0% | 10.7% | 41.0% | 22.2% | 12.0% | 10.7% |

*Note:
It is possible to have >100% relative light transmission with a channel film since reflections from the channel sidewalls can re-direct high angle light from the diffuse light source to the detector.

### Comparative Example 1 (CE-1): LBL Coated, No RIE, Dye Immersed

A coated film was made as described for EX-1. In this case, however, the film was not subjected to RIE. The film was immersed in a 0.5% solids solutions of Acid Fuchsin dye for 2 min, rinsed with DI water, and dried with compressed air. The film appeared fuchsia in color when viewed both on-axis (perpendicular to the plane of the film) and at an off-axis oblique angle (e.g., 45 degrees to the plane of the film) at a film orientation of 0 degrees. Visible light transmission and haze (Test Method #1) were 64.5% T and 13.2% H, respectively. Relative angular light transmission from a diffuse light source is shown in Table 4.

### Comparative Example 2 (CE-2): LBL Coated, No RIE, Pigment Immersed

A coated film was made as described for EX-6. In this case, however, the film was not subjected to RIE. The film was immersed in a 0.5% solids CAB-O-JET 200 (with 50 mM NaCl) for 2 min, rinsed with DI water, and dried with compressed air. The film appeared brown in color when viewed on-axis (perpendicular to the plane of the film) and darker brown in color when viewed at an off-axis oblique angle (e.g., 45 degrees to the plane of the film) at a film orientation of 0 degrees. Visible light transmission and haze (Test Method #1) were 68.9% T and 10.0% H. Relative angular light transmission from a diffuse light source is shown in Table 7.

### Comparative Examples 3 and 4 (CE-3 & CE-4): No LBL Coating, Immersed in Dye and Pigment

Two 2 inch×3 inch (5.1 cm×7.6 cm) pieces of film prepared in PE-1 were corona treated by hand on the structured side using a BD-20AC Laboratory Corona Treater (Electro-Technic Products, Chicago, IL) to facilitate wetting. Next, one piece of film was immersed in a 0.5% solids solutions of Acid Fuchsin dye for 2 min, rinsed with DI water, and dried with compressed air (CE-3). Visible light transmission and haze (Test Method #1) were 94.1% T and 11.1% H. The other piece of film was immersed in of 0.5% solids CAB-O-JET 200 (with 50 mM NaCl) for 2 min, rinsed with DI water, and dried with compressed air (CE-4). Visible light transmission and haze (Test Method #1) were 94.2% T and 10.9% H. Both CE-3 and CE-4 films appeared clear/colorless when viewed both on-axis (perpendicular to the plane of the film) and at an off-axis oblique angle (e.g., 45 degrees to the plane of the film) at a film orientation of 0 degrees.

### Prophetic Example 1: “Sharkfin” Microstructured Film

A microstructured film with a nearly triangular, “sharkfin” cross-section can be prepared as described in WO2020/250180 (Kenney et al.) (Preparative Example 1). The film can be conformally coated and etched as described in EX-1 using the “Method for Making Spray Layer-by-Layer Assembled Coatings on Microstructured Film” and then subjected to RIE, retaining the coating on the more vertical side walls.

### Prophetic Example 2: Linear Fresnel Lens Microstructured Film

A linear Fresnel lens microstructured film can be prepared as described in WO2021/090130 (Liu et al.). The film can be conformally coated using the “Method for Making Spray Layer-by-Layer Assembled Coatings on Microstructured Film” and the “Method for Reactive Ion Etching”, respectively, retaining the coating on the more vertical side walls.

### Prophetic Example 3: Post Array Microstructured Film

A microstructured film comprising an array of posts (e.g., cylindrical, hexagonal, or the like) can be made via replication from a master template as described in WO2020/097319 (Wolk et al.). The film can be conformally coated using the “Method for Making Spray Layer-by-Layer Assembled Coatings on Microstructured Film” and the “Method for Reactive Ion Etching”, respectively, retaining the coating on the walls of the posts.

### Prophetic Example 4: Cavity Array Microstructured Film

A microstructured film comprising an array of cavities (e.g., cylindrical, hexagonal, or the like) can be made via replication from a tool as described in U.S. Pat. No. 9,329,311 (Halverson et al.) using a resin as described in that reference, but without addition of any dyes or carbon black pigment. The film can be conformally coated using the “Method for Making Spray Layer-by-Layer Assembled Coatings on Microstructured Film” and the “Method for Reactive Ion Etching”, respectively, retaining the coating on the walls of the cavities.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A coated microstructured film comprising:
a) a plurality of microstructures extending across a first surface of the microstructured film; and
b) a coating disposed on a first portion of at least some of the microstructures, the coating comprising one or more polyelectrolytes, the coating having an average thickness T, wherein a second portion of the coated microstructures either lacks the coating or comprises the coating disposed thereon having an average thickness of no more than 50% of T; wherein the coating is essentially free of any light absorptive material,
wherein the coated microstructured film exhibits a transmission of visible light of 75% or greater at a viewing angle of +45 degrees.

2. The coated microstructured film of claim 1, wherein the microstructures comprise a plurality of ribs alternated with channels extending across the first surface of the microstructured film, wherein each of the ribs comprises side walls and a top surface and each of the channels comprises a bottom surface; and wherein the first portion on which the coating is disposed comprises the side walls of the ribs and the second portion comprises the top surfaces of the ribs and the bottom surfaces of the channels.

3. The coated microstructured film of claim 2, wherein each rib has a width W and a height H and wherein H/W≥1.5.

4. The coated microstructured film of claim 1, wherein the microstructures comprise a facet and a side wall meeting the facet at a ridge of the microstructure and wherein the facet and the side wall define an oblique angle therebetween; and wherein the first portion on which the coating is disposed comprises the side wall and the second portion comprises the facet.

5. The coated microstructured film of claim 4, wherein each of the microstructures is a) a linear prism having a substantially same angle between the optical facet and the side wall or b) a linear Fresnel element.

6. The coated microstructured film of claim 1, wherein the microstructures comprise a two-dimensional (x- & y-axes) array of projections arranged across the first surface of the microstructured film; wherein each of the projections comprises a base, a top, and one or more sides connecting the top to the base; and wherein the first portion on which the coating is disposed comprises the sides and the second portion comprises the top.

7. The coated microstructured film of claim 6, wherein each of the projections is a spaced apart post and the second portion further comprises a surface of the microstructured film between the spaced apart posts.

8. The coated microstructured film of claim 1, wherein the microstructured film comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening; and wherein the first portion on which the coating is disposed comprises the at least one side wall and the second portion comprises at least one of the first major surface or the second major surface of the microstructured layer.

9. The coated microstructured film of claim 8, wherein each of the at least one side walls forms a side wall angle θ with a line perpendicular to the first major surface of the microstructured layer.

10. The coated microstructured film of claim 1, wherein the coated microstructured film exhibits a transmission of visible light of 75% or greater at a viewing angle of 0 degrees.

11. (canceled)

12. The coated microstructured film of claim 1, wherein the polyelectrolytes comprise polymers containing quaternary ammonium groups or sulfonic acid groups.

13. The coated microstructured film of claim 1, wherein the polyelectrolytes comprise polymers containing primary, secondary, or tertiary amines, or carboxylic acids, or phosphonic acids.

14. The coated microstructured film of claim 1, wherein a surface of the coating exhibits a positive zeta potential at a pH in the range of 1-14.

15. A method of making a coated microstructured film of claim 1, the method comprising:
a) obtaining a microstructured film comprising a plurality of microstructures extending across a first surface of the microstructured film;
b) applying a coating comprising one or more polyelectrolytes to at least some of the microstructures across the first surface of the microstructured film, the coating having an average thickness T, wherein the coating is essentially free of any light absorptive material; and
c) removing at least a portion of the coating from a second portion of the coated microstructures to provide the coating disposed on a first portion of the coated microstructures.

16. A method of making a light control film, the method comprising:
a) obtaining a microstructured film comprising a plurality of microstructures extending across a first surface of the microstructured film;
b) applying a coating comprising one or more polyelectrolytes to at least some of the microstructures across the first surface of the microstructured film, the coating having an average thickness T; and
c) removing at least a portion of the coating from a second portion of the coated microstructures to provide the coating disposed on a first portion of the coated microstructures, thereby forming a coated microstructured film; and
d) either i) infusing a light absorptive material into the coating of the coated microstructured film or ii) applying a layer of a pigment on the coating;
wherein the light control film exhibits a transmission of visible light of 75% or greater at a viewing angle of 0 degrees.

17. The method of claim 16, wherein the microstructures comprise a plurality of ribs alternated with channels extending across the first surface of the microstructured film, and wherein the method further comprises filling the channels with an organic polymeric material.

18. The method of claim 16, wherein the light absorptive material comprises at least one ionic dye.

19. The method of claim 16, wherein step d) comprises i) and further comprises applying a layer of a pigment on the coating after step d).

20. The method of claim 16, further comprising, prior to step d):
e) preparing a roll of the coated microstructured film; and
f) cutting at least one piece of the coated microstructured film from the roll,
wherein step d) is performed on at least one of the pieces of the coated microstructured film.
